(19) United States
(12) Patent Application Publication
(10) Pub. No.: US 2013/0006592 A1
(43) Pub. Date: Jan. 3, 2013

(54) Computer-Implemented Models Predicting Outcome Variables and Characterizing More Fundamental Underlying Conditions

(75) Inventor: Jay Magidson, Arlington, MA (US)

(73) Assignee: STATISTICAL INNOVATIONS, INC., Belmont, MA (US)

(21) Appl. No.: 13/520,407

(22) PCT Filed: Jan. 12, 2011
(86) PCT No.: PCT/US2011/020959

§ 371 Date: Jul. 3, 2012

Related U.S. Application Data
(60) Provisional application No. 61/294,343, filed on Jan. 12, 2010.
(60) Provisional application No. 61/296,754, filed on Jan. 20, 2010.

(51) Int. Cl. G06F 17/10

(52) U.S. Cl. 703/2

(57) ABSTRACT

A method and device predict an outcome variable of an observed phenomenon based on values of a panel of three or more observed constituents and, to do so, employ a series of processes, implemented by a machine, for developing a K-component linear model wherein, among other things, the first component is by itself significantly predictive of the outcome variable, and a second component is correlated with the first component, and loadings for each constituent within any given one of the components subsequent to the first component are determined in a sequentially independent manner.

### RELATED APPLICATIONS

The present application claims priority from U.S. provisional patent application Ser. No. 61/294,343, filed Jan. 12, 2010, and from U.S. provisional patent application Ser. No. 61/296,754, filed Jan. 20, 2010, both of which priority applications are incorporated herein by reference.

### TECHNICAL FIELD

The present invention relates to computer-implemented models predicting outcome variables and characterizing more fundamental underlying conditions, including predictions derived from values of constituents in panels, such as panels of genes and panels of voxels or pixels in a region of the brain, reflecting an underlying biological, mental, or other condition.

### BACKGROUND ART

It is known in the prior art how to derive predictions for outcome variables from data on G predictor variables obtained on a sample of N cases, and when G is large the prior art provides methods to reduce the number of predictors to G*<G. However, weaknesses and limitations exist in both the predictions as well as the variable reduction methodologies. Regarding the predictive models, the table below lists techniques for developing predictive models and summarizes many of these weaknesses.

| | | Special | | |
|---|---|---|---|---|
| | Appropriate | methods | | |
| | for large # | to isolate | Handles | |
| | predictors | suppressor | Missing | |
| | (G > N) | variables | Data Easily | Unbiased |
| Linear Regression | NO | NO | YES | YES |
| Ridge Regression | NO | NO | YES | NO |
| Logistic Regression | NO | NO | NO | YES |
| Discriminant | NO | NO | NO | YES |
| Analysis | | | | |
| Cox Regression | NO | NO | NO | YES |
| PLS Regression | YES | NO | NO | YES |

Each of the references listed at the conclusion of this description is hereby incorporated herein by reference.

### SUMMARY OF THE INVENTION

Embodiments of the present invention provide advantages over the prior art and, with respect to the chart above, can provide the answer “Yes” to each of the criteria listed above. In addition, other embodiments have advantages over the prior art with respect to variable reduction.

In accordance with preferred embodiments of the present invention, methods are provided for predicting an outcome variable of an observed phenomenon based on values of a panel of three or more observed constituents (where the number of constituents will be labeled G). The prediction is based on a number N>4 of cases, where the cases collectively provide values for all constituents of the panel, and where, for each constituent, there are at least two cases having mutually distinct values, and where at least two cases have mutually distinct values for the outcome variable. Moreover, there is at least one additional case in which values for at least some constituents of the panel of constituents are provided and from which the outcome variable is to be predicted.

As described in further detail below, embodiments of the present invention use a panel of constituents including gene constituents to characterize quantitatively a state of a subject as to a biological condition. More particularly, the gene constituents may have gene expression values. In the prior art, it is generally taught that in using a panel of genes to characterize biological condition, one should select the panel so that each gene in the panel contributes to the prediction of the outcome (namely characterization of biological condition) in a manner that is statistically significant independent of the other genes in the panel. The embodiments herein claimed operate in a manner contrary to such teaching by including in the panel one or more gene constituents that do not contribute in a statistically significant manner to the prediction of the outcome independent of the other genes but whose statistically significant contribution to the outcome depends totally on one or more other gene constituents.

A simple example is instructive. FIGS. 2A and 2B (discussed in further detail below) involve a sample of men with Prostate Cancer (CaP) and an age-matched sample of normals. FIGS. 2A and 2B display scatterplots of gene expression values for the genes CD97 and SP1 (in delta ct units) from the training and validation data, with separate 68% concentration ellipsoids superimposed for the cancer and normal subjects. From a visual perspective, the validation data supports the hypothesis developed from the training data that the concentration ellipses provide good separation of CaP and normals. Most normals are contained within the lower ellipse while most CaP subjects are contained within the upper ellipse. The mean expression value for the gene SP1 is identical in both groups, and thus SP1 does not contribute to the prediction of the outcome (cancer vs. normal) in the absence of CD97. However, classification based on expression values of both CD97 and SP1 is improved significantly over prediction based solely on CD97. In other words, the significant contribution to outcome of the second gene (SP1) would not exist at all in the absence of the first gene (CD97) but still improves the prediction accuracy. The scatterplots also show evidence of a high positive correlation between CD97 and SP1 in both groups.

In statistical parlance, the second gene, SP1, is called a “suppressor” variable, because it has the effect of enhancing the predictive contribution of the first gene, CD97, using its correlation with the first gene to remove (suppress) some irrelevant variation. Although not referring to suppressor variables explicitly, Fan and Lv (2008) recognize their importance and the failure of a prior art statistical methodology called SIS to include them among the selected predictors. To deal with this failure, they proposed an iterative version of SIS called ISIS, and show that ISIS is much more likely to include suppressor variables using simulated data.

We show here that embodiments of the present invention outperform ISIS on data simulated according to LDA assumptions based on the specifications provided by Fan and Lv (2008). FIG. 12 shows the results of an ISIS procedure (represented by the lower curve) versus a procedure based on embodiments claimed herein (represented by the upper curve) on such data. In particular FIG. 12 shows the percentage of the time each procedure successfully includes all 4 true variables in a final model containing only G predictors, G=4, 5, . . . , 10. Using embodiments herein the model includes the suppressor variable X₄ among the 10 top predictors 91% of the time compared to only 80% for ISIS. In addition, ISIS performed very poorly when fewer than 7 predictors were selected. Details of the simulation are given at the end of this application beginning in paragraph [00152].

Using gene constituents to characterize quantitatively a state of a subject as to a biological condition is merely one of many possible uses for embodiments of the present invention. For example, in discussing FIGS. 10A and 10B below, we show applicability of embodiments of the present invention to analysis of fMRI brain pixel measurements.

Methods provided in accordance with these embodiments of the present invention have steps of loading a predictive model into a digital computing device, and then inputting into the digital computing device the constituent values from the additional case or cases, and using the model in the digital computing device to predict a value for the outcome variable for each of the additional cases. The model loaded into the digital computing device for predicting the outcome variable is developed by establishing in a digital computer a machine for developing a K-component linear model of the observed phenomenon, predictive of an outcome variable for the phenomenon, wherein the machine implements processes comprising:

computing in a series of computer processes a weighted sum of K>1 components, each one of the K components having a component weight, each component subsequent to a first component being itself a linear combination of constituents in the panel, wherein the first component is by itself significantly predictive of the outcome variable, and a second component is correlated with the first component;
wherein the computing in a series of computer processes includes

(i) determining, from the N cases, in a sequentially independent manner, loadings, for each constituent within any given one of the components subsequent to the first component, and storing the loadings, and

(ii) determining and storing the component weights, wherein each component subsequent to the first component enhances accuracy of prediction collectively by all preceding components; and

using the machine, that has been established in this way, to develop the model. The processes implemented by the machine are sometimes called herein “Correlated Component Regression” (CCR).

In accordance with alternate embodiments of the present invention, a digital computing device is provided that predicts an outcome variable of an observed phenomenon based on values of a panel of G≧3 observed constituents and N>4 cases, the cases collectively providing values for all constituents of the panel. The device has a processor; and a memory that stores instructions that are executable by the processor. The instructions, in turn, (a) cause the computing device to perform processes that include storing constituent values inputted to the digital computing device from the at least one additional case; and (b) establish in the computing device a model that predicts a value for the outcome variable for each of the at least one additional case.

The model established in the computing device has been developed by:
establishing in a digital computer a machine for developing a K-component linear model of the observed phenomenon, wherein such model (i) predicts an outcome variable for the phenomenon, based on values of the panel of G observed constituents, G≧3, and (ii) is developed from the N>4 cases, wherein the machine implements processes comprising:
computing in a series of computer processes a weighted sum of K>1 components, each one of the K components having a component weight, each component subsequent to a first component being itself a linear combination of constituents in the panel, wherein the first component is by itself significantly predictive of the outcome variable, and a second component is correlated with the first component;
wherein the computing in a series of computer processes includes

(i) determining, from the N cases, in a sequentially independent manner, loadings, for each constituent within any given one of the components subsequent to the first component, and storing the loadings, and

(ii) determining and storing the component weights, wherein each component subsequent to the first component enhances accuracy of prediction collectively by all preceding components; and
using the machine thus established to develop the model.

In accordance with further embodiments of the present invention, a computer-readable non-transitory storage medium is provided that is encoded with instructions that, when loaded into a computer, establish a machine for developing a K-component linear model of an observed phenomenon, wherein such model (i) predicts an outcome variable for the phenomenon based on values of a panel of G observed constituents, G≧3. The machine established in the computer implements processes comprising:

computing in a series of computer processes a weighted sum of K>1 components, each one of the K components having a component weight, each component subsequent to a first component being itself a linear combination of values of each constituent in the panel, wherein the first component is by itself significantly predictive of the outcome variable, and a second component is correlated with the first component;

wherein the computing in a series of computer processes includes

(i) determining, from the N cases, in a sequentially independent manner, loadings, for each constituent within any given one of the components subsequent to the first component, and storing the loadings, and

(ii) determining and storing the component weights, wherein each component subsequent to the first component enhances accuracy of prediction collectively by all preceding components.

In any of the foregoing embodiments, the machine may implement further processes comprising:

in a second series of computer processes, determining a composite weight for each constituent in each K-component model by summing, over all K components, the product of the constituent's loading in each component and the corresponding weight for such component, and storing and using the composite weight to establish a measure of predictive importance of each constituent in the K-component model; and

in a third series of computer processes, simplifying the model by removing at least one constituent according to a pre-specified rule taking into account the measures of predictive importance of at least one constituent.

The panel of constituents that serves as the basis for establishing the model in any of the foregoing embodiments may include gene constituents, and each gene constituent in any instance may have a gene expression value, and, optionally, each output outcome variable may characterize quantitatively a state of a subject as to a biological condition. One or more of the constituents may also be a covariate.

One of the ways in which the predictive accuracy of the model may be improved, in accordance with certain embodiments of the invention, is by removing at least one less important constituent according to a pre-specified rule that further takes into account the measures of predictive importance of each constituent. Establishing a measure of predictive importance may include converting the composite weights into standardized weights so that a constituent having a lowest standardized composite weight contributes least in predicting the outcome variable. Converting the composite weights into standardized composite weights may be accomplished by determining a magnitude of the product of each predictor composite weight and a standard deviation of the constituent computed from the N cases.

In accordance with yet further embodiments of the present invention, the machine may implements further processes such as repeating the second and third series of computer processes to remove constituents until the model's accuracy of prediction is optimized with respect to the number of constituents employed therein.

The step of determining the loadings in a sequentially independent manner for each constituent may be based optionally on a maximum likelihood method, and may also optionally be based on an assumption of normally distributed errors. Converting the composite weights into standardized composite weights may include determining a magnitude of the product of each of a plurality of constituent composite weight and a standard deviation of the constituent computed from the N cases.

Using the composite weight to establish a measure of predictive importance may include determining a monotonic function of a product of the composite weight and a standard deviation of the constituent associated with the composite weight, such function preserving an order of importance of the constituents determined by the absolute value of the product.

In various of the embodiments of the invention in which the model is simplified, simplification may include using a pre-specified rule requiring a retention set of constituents to remain in the model regardless of measures of predictive importance thereof.

The second series of computer processes may include converting the composite weights into standardized composite weights so that a constituent having a lowest standardized composite weight contributes least in predicting the outcome, the third series of computer processes may include removing the constituent having the lowest standardized composite weight from the new model, and a fourth series of computer processes may include determining new composite weights using the constituents remaining in the model. The machine may then perform the second, third, and fourth computer processes iteratively until the new model satisfies a design criterion, such as that of including no more than a specified number of constituents, or that of removing constituents from the model until just before the model loses accuracy of prediction by a desired amount.

### BRIEF DESCRIPTION OF THE DRAWINGS

The foregoing features of the invention will be more readily understood by reference to the following detailed description, taken with reference to the accompanying drawings, in which:

FIG. 1 is a diagram of computer processes used to implement an embodiment of the present invention.

FIGS. 2A and 2B are plots of prime gene expression values (of CD97) on the vertical axis versus proxy gene expression values (of SP1) on the horizontal axis in training data and validation data respectively in normal subjects, represented by small circle data points (in blue in the original figures), and in prostate cancer subjects, represented by small square data points (in red in the original figures), and wherein most normal subjects are contained in the lower (blue) ellipse and most prostate cancer subjects are contained in the upper (red) ellipse.

FIGS. 3A and 3B are also plots of prime gene expression values (of CD97) versus proxy gene expression values (of SP1) in training data and validation data respectively in normal subjects, represented by small circle data points (in blue in the original figures), and in prostate cancer subjects, represented by small triangular data points (in red in the original figures). In these figures, however, the actual gene expression values for the gene CD97 are downshifted by 0.53* ct, with result that the ellipses for both normal and prostate cancer subjects are coincidental for both training data and validation data.

FIGS. 4A and 4B are similar plots of prime gene expression values (of CD97) versus proxy gene expression values (of SP1) in training data and validation data respectively in normal subjects, represented by small circle data points (in blue in the original figures), and in prostate cancer subjects, represented by small square data points (in red in the original figures). In FIG. 4A, the data are exactly the same as in FIG. 2A, whereas in FIG. 4B, the actual gene expression values for the gene CD97 for each case are shifted by a predicted value for CD97 given the value of SP1 for normal subjects in the two-gene model of FIG. 4A. The plot shows precisely that for normal subjects the mean value on the adjusted CD97 score is 0 and that for prostate cancer cases, the adjusted C97 score is elevated over the mean value for normals.

FIGS. 5A and 5B show boxplots showing how the performance measure changes as K increases from K=1 to K=5 based on the validation data for the 8-gene model (FIG. 5B) and for the 22-gene model (FIG. 5A).

FIG. 6 shows boxplots showing how the AMPS average model performance statistic changes as the number of components K increases from K=1 to K=3 obtained on the validation data for CaP1, CaP4, and Normals. Normals are used as the reference category for the outcome variable so that AMPS=0 for Normals.

FIGS. 7A and 7B show ROC curves showing the area under the curve (AUC) for early stage prostate cancer subjects CaP1 (FIG. 7A) and late stage prostate cancer subjects CaP4 (FIG. 7B).

FIGS. 8A and 8B provides a conceptual path diagram showing that the prediction of the outcome variable Z is obtained as a weighted sum of the K-components where the estimated component weights are used to weight the components. If covariates are treated the same way as constituent variables, then each component itself is computed as a weighted sum of both the constituents and components. On the other hand, if there are no covariates or if the covariates are treated so as to have direct effects on the outcome variable as shown in FIG. 8B, then each component is computed as a weighted sum of the constituents alone.

FIGS. 9A and 9B show how a K-component model is used to obtain a predicted score for a new case. FIG. 9A illustrates this in the absence of covariates and FIG. 9B illustrates this when covariates are included in the model.

FIGS. 10A and 10B illustrate the results of analysis of fMRI data using K-component models. Predictions were obtained from 3,445 fMRI brain pixel measurements using the 4-component model, for each of N=360 time points corresponding to 12 cycles, where the 1^{st} 4 cycles were used as the training sample to develop the model and the remaining 8 cycles were used to validate the model. FIG. 10A shows the predicted outcome score Logit.4 plotted as a function of time, where the first 4 time cycles correspond to the training data and the remaining 8 cycles correspond to the validation time points. Each cycle is split into a first half (30 time points) corresponding to when a control video is seen followed by a second half (also 30 time points) corresponding to when a video is seen of people getting high on cocaine. FIG. 10B summarizes the performance of the various K-component models in predicting a dichotomous outcome variable Z, where Z=1 corresponds to the cocaine video time points and Z=0 corresponds to the control video time points. The predicted outcome score obtained from the K-component model is denoted by Logit.K. As the number of components is increased the performance is improved, with Logit.4 being the peak performance and Logit.1 being the weakest performance, according to the validation time points. ROC curves are provided as well as the area under the curve associated with these curves for each K-component model. The second column of the table shows that prediction of the outcome variable is perfect in the training time points beginning with the 2-component model (area under curve=1) and, surprisingly, despite the fact that there is perfect prediction of the training points with the 2-component model, prediction of validation data shows that model continues to improve for additional components up through the 4-component model (area under curve peaks at 0.95).

FIG. 11 depicts plots of the cross-validation accuracy and area-under-the-ROC curve based on a 3-component model for the number of predictors P ranging from 50 down to 1.

FIG. 12 shows the results of an ISIS procedure versus a procedure based on embodiments claimed herein on such data.

### DETAILED DESCRIPTION OF SPECIFIC EMBODIMENTS

### Brief Summary of Notation

Z an outcome variable

Y_{g} gth constituent variable, g=1, 2, . . . , G
s=1, . . . .

Xₘ mth covariate, m=1, 2, . . . , M

Sₖ kth component in K-component model

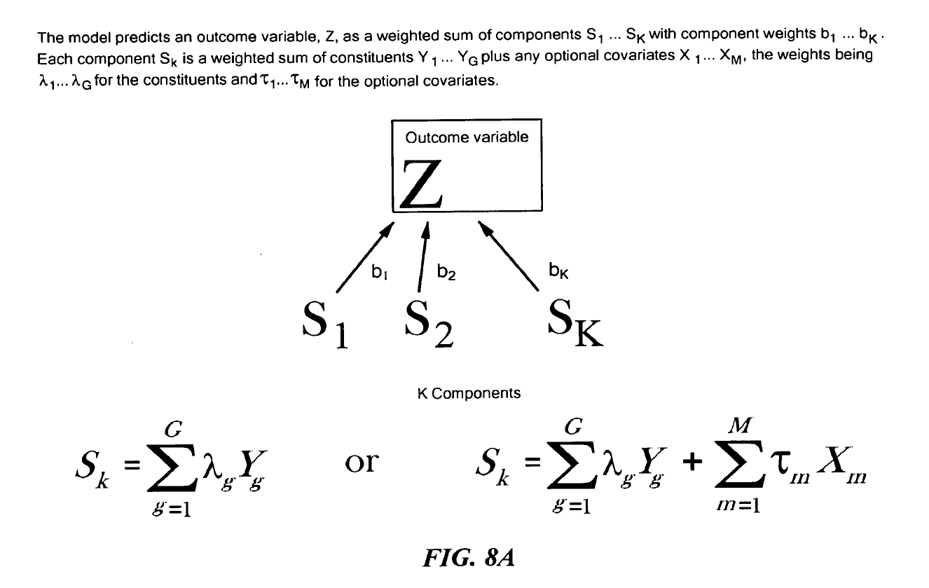

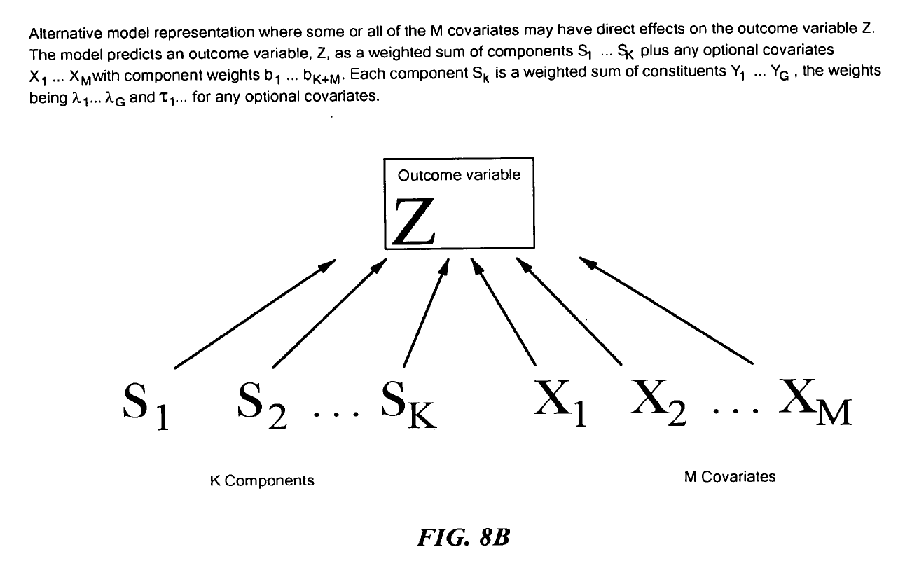

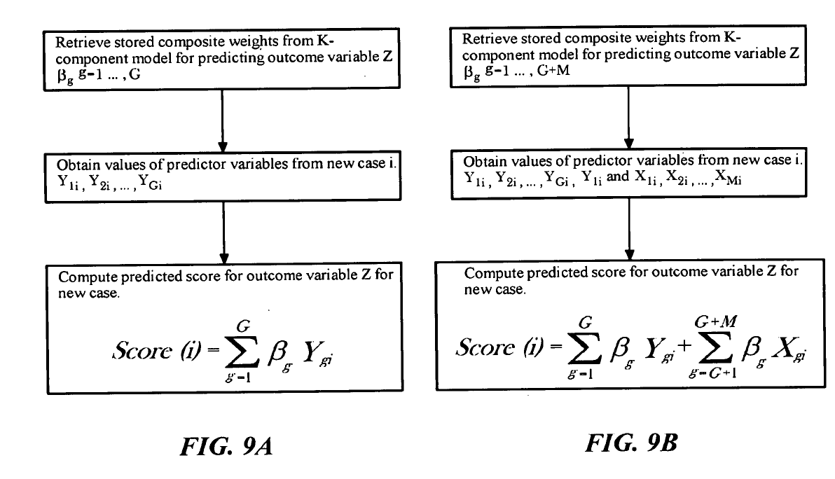

bₖ component weight for the kth component in equation predicting outcome variable (see for example, FIG. 8A)

λ_{g}, or λ_{kg} loadings on the kth component associated with the gth constituent, g=1, 2, . . . , G

λ*_{g}, or λ*_{kg} standardized loadings on the kth component associated with the gth constituent, g=1, 2, . . . , G

τₘ loadings on the kth component associated with the mth covariate, m=1, 2, . . . , M as shown in FIG. 8A (optional). This is not used if the covariates are allowed to have direct effects on the outcome variable as shown in FIG. 8B.

β_{g}, βₘ composite weight for the gth constituent or mth covariate used for predicting an outcome variable (see paragraph [0057]).

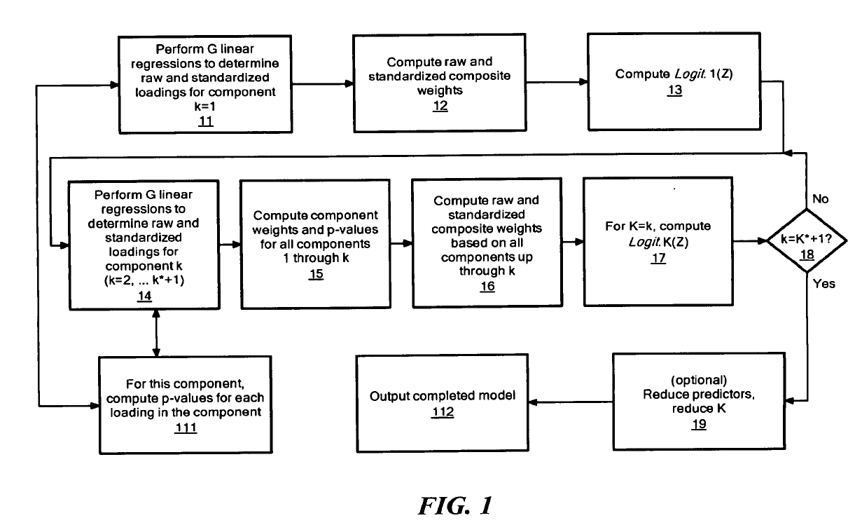

β*_{g}, β*ₘ standardized composite weights for the gth constituent or mth covariate used as a measure of importance when applying the variable reduction algorithm as shown in processing step 19 in FIG. 1.

λ′_{g}, or λ′_{kg} preliminary quantity for categorical outcome variable used to determine loading by dividing it by the appropriate MSE (see paragraph [00100]).

Logit.K(Z) denotes predictions of outcome Z for the cases, obtained from a K-component model. When the outcome variable is categorical, Logit.K(Z), when the appropriate constant is added, can be interpreted as the log of the odds associated with outcome with a particular category of Z vs. some designated reference category of Z. For further discussion, see paragraphs [0043], [0057], and [0064].

ν,γ nuisance parameters.

Definitions.

As used in this description and the accompanying claims, the following terms shall have the meanings indicated, unless the context otherwise requires:

A “case” is a sample observation (including values of constituents and at least one outcome variable) with respect to a “subject” or “time point”, and is associated with an index i=1, 2, . . . , N, where N cases, collectively being referred to as the “training sample”, are used to develop at least one model, and scores obtained from the model are applied to an independent “validation sample”, when available, consisting of additional cases for the purpose of validating the model and possibly other purposes.

An “observed constituent” (which is also herein called simply a “constituent”) is a constituent that is associated with a phenomenon and has a value that may be obtained by at least one of direct observation and an instrument reading, wherein the instrument reading may, but need not be, automated. The phenomenon may be natural or the result of human activity in the physical world. In statistical parlance, a “constituent” may be regarded as, and is sometimes referred to herein as, a “predictor variable” or simply a “predictor”.

The term “characterizing quantitatively the state of a subject” includes predicting a value for an outcome variable based on values of a panel of constituents associated with a case.

The term “gene expression values” means continuous measurements of the concentration of any molecular-level entity that may be deemed to be associated with biological condition, including mRNA or protein, as well as any micro-RNA, ribosomal RNA, small nucleolar RNA, transfer RNA, etc.

The term “outcome category”, synonymous with “outcome”, refers to a particular category of a “categorical outcome variable”.

The term “outcome score”, synonymous with “outcome value”, refers to a quantitative value associated with a given category or level of an “outcome variable”.

An “outcome variable” Z is a manifest (observable) or latent variable containing at least one set of quantitative values for cases that is believed to be correlated with an underlying biological condition of the cases, and may be categorical (“categorical outcome variable”) which may be nominal or ordinal, continuous or Z may denote an event history. A nominal outcome variable with J>1 distinct mutually exclusive outcome categories may be represented by J dichotomous outcome indicator variables Z=(Z₁, Z₂, . . . , Z_{J}) such that for a given case, Zⱼ=1 if the jth outcome occurs and Zⱼ=0 otherwise, j=1, 2, . . . , J. Since each case is in one and only one outcome category, for each case

$${\sum }_{j = 1}^{J} {Z}_{j} = 1 ,$$

which means that the particular outcome category for each case is uniquely determined by the scores on any J−1 of these dummy variables, the omitted category j′, referred to as the ‘reference category’, being these indicator variables, these omitted category j′ referred to as the ‘reference category’, being equal to

$$1 - {\sum }_{j \neq {j}^{′}} {Z}_{j} .$$

When J=2, the outcomes can be represented by a single dichotomous outcome variable Z, where Z=1 for say the first outcome (e.g., Cancer) and Z=0 for the other outcome (e.g., Normal). Optionally, in a context involving at least one covariate, a new outcome variable can be defined, based on the original outcome variable, and modified to include removal of covariate effects from the original outcome variable, as described below in connection with FIG. 8B.

An ordinal outcome variable Z has J>2 distinct mutually exclusive outcome categories that are ordered uniquely by a set of J outcome scores, one such score being associated with each category. These scores determine the relative distance between any 2 categories. By convention, the J categories will be ordered from low to high so that the first outcome category (j=1) is associated with the lowest score Z*[1] and the last (j=J) with the highest score Z*[J]. In addition, without loss of generality any set of outcome scores Z*=Z*[1], Z*[2], . . . , Z*[J] will be re-scaled to Z=Z[1], Z[2], . . . , Z[J] such that Z[1]=0 and Z[J]=1, using the following formula:

Z[j]=(Z*[j]−Z*[1])/(Z*[J]−Z*[1]), j=1, 2, . . . , J

Thus, for example, the ordinal variable Z consisting of the 3 outcome categories ‘Normal’, ‘Early stage Prostate Cancer’, and ‘Late Stage Prostate Cancer’ may be assigned the outcome scores ‘0’, ‘0.3’ and ‘1’ respectively, which means that, cases with ‘Early stage Prostate Cancer’ are closer to ‘Normals’ than to ‘Late Stage Prostate Cancer’. The outcome scores may be specified or they may be determined by the model. As a particular embodiment, the scores of ‘0’ and ‘1’ can be assigned to 2 specific outcome categories corresponding to the 2 extreme outcomes and the approach will determine the other category scores in such a way that they are between 0 and 1.

A continuous outcome variable Z may take on up to N distinct values, one for each of the N cases. For example, a continuous Z may be normally distributed in some population.

An outcome variable representing an event history consists of a dichotomous variable Z=1 if the event (e.g., death) occurs and Z=0 if it has not occurred at any particular time, and a continuous or discrete exposure variable W which quantifies the elapsed time since some baseline event (e.g., diagnosis of late stage prostate cancer). For each case i, there exists a set of Nᵢ data points representing the event history for that case (see e.g., Vermunt 2009).

An estimated weight is “statistically significant” if the difference between the estimated weight and zero is beyond that attributable to random error alone. If the p-value associated with the estimated weight, computed under the null hypothesis that the weight is zero, falls below a specified level, traditionally, the 0.05 level, then the estimated weight is said to be “statistically significant” (at the 0.05 level).

“Maximum likelihood methods” estimate one or more parameters in a manner that maximize a likelihood function based on an assumed distribution (or a posterior distribution associated with an assumed prior distribution), and statistics (e.g., p-values) are available to assess the fit of a model (e.g., a K-component model) to determine whether increasing the number of components can improve prediction by a statistically significant amount.

A “sequentially independent manner” is a manner wherein, during any computer processing step, whenever a variable corresponding to a given constituent is used as a dependent variable or a predictor in some regression model, the none of the other G−1 constituents are included in the regression model in their original units as either a dependent variable or a predictor, and if included in different units, the second component is uncorrelated with the first component as further described herein. If original units are used, then the first component and additional components may also be included in the model. The concept of “sequentially independent” manner in conjunction with original vs. diminished units is explained in more detail and illustrated in paragraphs [00120]-[00141].

“Sequential independence” between an outcome variable and a set of predictors in a K-component model means that the outcome variable is statistically independent of the predictors given the predictions of the outcome obtained by the model. If original units are used in the regression models in all steps, sequential independence is achieved by the model if the p-value associated with at least one component weight in the model is not statistically significant. As a preferred embodiment, we test to determine if the p-value associated with each of the K component weights is statistically significant. If this test is affirmative, an additional component is extracted and updated p-values are computed for each of the K+1-component weights. After repeated application of this test, if one or more p-values is found to be non-significant, (say after extracting K*+1 components), then the K*-component model is said to achieve ‘sequential independence’, and K* is taken equal to the lowest value of K that achieves ‘sequential independence’. If sequential independence is not achieved by the K-component model, an additional component can improve predictions by a statistically significant amount, prediction being achieved by a linear combination of the K+1 components in a K+1-component model.

A “covariate” is a categorical or continuous variable that is predictive of an outcome variable. Examples of possible covariates are AGE, GENDER, a predictive score obtained from a model developed earlier. Other examples include non-linear functions of gene expression values themselves. A covariate either is treated in the K-component model in the same way as a constituent, as depicted in FIG. 8A, or is allowed to have its own direct effects on the outcome variable Z, as depicted in FIG. 8B.

“Digital computer system” includes a programmable calculator or other programmable device.

A “predictor”, synonymous with “predictor variable”, includes a variable quantifying a constituent of a panel of constituents and any covariates used in a model to predict an outcome variable. Examples of a panel of constituents include a panel of genes, as well as a panel of voxels or pixels in a region of the brain; in each case, a predictor corresponds to a quantitative measurement of a constituent (such as obtained from quantitative PCR or fMRI), or a covariate.

A “retention set of constituents and covariates” is a set that includes at least one constituent or covariate, and may include only constituents or only covariates or a combination of constituents and covariates.

A “loading” for a predictor in the kth component of a K-component model is a coefficient for the predictor in an equation defining the component as a linear combination of all predictors. Each predictor in the model has K loadings associated with it, one for each of the K components.

A “composite weight” is an aggregate coefficient for a predictor in a K-component model determined as a linear combination of the loadings for the predictor in each component weighted by the associated component weight. The composite weights are used to obtain a prediction of an outcome variable as a weighted sum of all predictors in the model plus a constant, each predictor being weighted by its associated composite weight. As a preferred embodiment in the situation where the outcome variable is categorical, the composite weight is interpretable as a log-odds ratio, the prediction being in logit units.

A “component weight” is a regression coefficient for each component in a model predicting an outcome variable, each component being defined as a linear combination of the predictors in the associated K-component model.

A “prime constituent” is a constituent for which its corresponding variable has a loading that is statistically significant in the first component of a K-component model (K>1), wherein the first component is derived by following the procedures described in connection with FIG. 1. When the prime constituent is a gene, it is called a “prime gene”. The constituent CD97 is an example of a prime gene as shown by output obtained from the 4-component/8-constituent model in Table 1A, where highlighted loadings are statistically significant at the 0.05 level. The constituent SP1 is an example of a proxy gene as shown by output obtained from the 4-component/8-constituent model in Table 1A, where highlighted loadings are statistically significant at the 0.05 level. From the example based on fMRI data, 18% of the voxels in the brain turn out to be prime constituents having activity during the cocaine video significantly different from their activity during the control video.

A “proxy constituent” is a constituent having a non-statistically significant loading in the first component, and a statistically significant loading in the second component, of a K-component model (K>1) and wherein the second component is correlated with the first component, and wherein the components are derived by following the procedures described in connection with FIG. 1. When the proxy constituent is a gene, it is called a “proxy gene”. From the example based on fMRI data, 6.5% of the voxels in the brain turn out be proxy constituents, which do not have activity during the cocaine video significantly different from their activity in the control video, but they have activity that is correlated with at least one prime constituent and they significantly enhance prediction by having a significant loading in the second component.

“Correlated Component Regression” (CCR) is a series of processes, implemented by a machine in accordance with embodiments of the present invention, for developing a K-component linear model wherein, among other things, the first component is by itself significantly predictive of the outcome variable, and a second component is correlated with the first component, and loadings for each constituent within any given one of the components subsequent to the first component are determined in a sequentially independent manner.

Embodiments of the present invention provide a computer-implemented method for developing a model that predicts at least one outcome variable as a function of values of predictor variables. The predictor variables, in turn, may include a panel of constituents and any covariates used in the model. Examples of the panel of constituents are a panel of genes, as well as a panel of voxels or pixels in a region of the brain; in each case, a predictor corresponds to a quantitative measurement of a constituent (such as obtained from quantitative PCR or fMRI) reflecting an underlying biological, mental, or other condition.

Accordingly, in the context of gene expression, embodiments of present invention provide a computer-implemented method for developing a model that characterizes quantitatively a state of a subject as to a biological condition, based on gene expression values of a panel of at least two gene constituents that are predictive of at least one outcome variable, the model developed from N cases, the cases collectively providing gene expression values for all constituents of the panel, wherein, for any given constituent, there exist at least three different cases having gene expression values for the constituent and also having distinct outcome scores on at least one outcome variable. In various embodiments, the model may be developed according to processes as follows. (Although we are describing these processes in mathematical terms, it will be understood that these processes are, and must be, implemented in a digital computer system, as we shall describe later in further detail.)

The outcome variables are indicative of one or more underlying biological conditions. For simplicity, consider a single dichotomous (J=2) outcome variable Z with category scores of Z[1]=1 for cases with Prostate Cancer (category j=1) and Z[2]=0 for normal cases (category j=2). Further assume no missing data on G continuous predictors Y₁, Y₂, . . . , Y_{G}, each of which represents gene expression values (no covariates) for the N cases, where G may be much larger than N. For a given number of components in the model K≦G, the kth component (variable) is denoted as Sₖ, k=1, 2, . . . , K, and is defined as a weighted sum of the G predictors. Each case i has a particular score, Sₖᵢ, on component k=1, 2, . . . , K. The continuous score representing the underlying condition, Logit.K(Z), is expressed as a linear combination of the components and optionally, as depicted in FIG. 8B, covariates. As a preferred embodiment, the mean value for Logit.K(Z) is set to equal 0 for Z=0 (normals), and values greater than 0 on Logit.K(Z) reflect a higher probability of having outcome score Z=1 than the average normal case. The composite weight β_{g} for constituent g in the equation for Logit.K(Z) is interpretable as a (partial) log-odds ratio. Thus, the odds in favor of an outcome score Z=1 is exp(β_{g}) times as high for a case for which the Y_{g} value is 1 unit higher than another case having the same values on the remaining G−1 predictor variables.

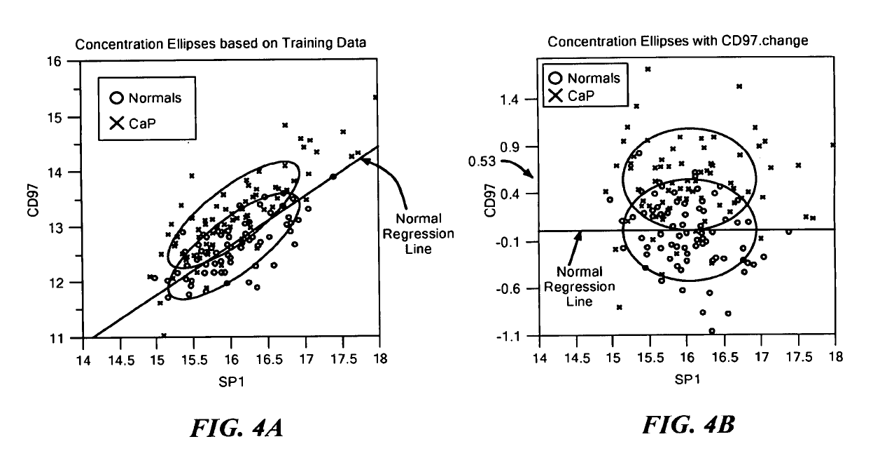

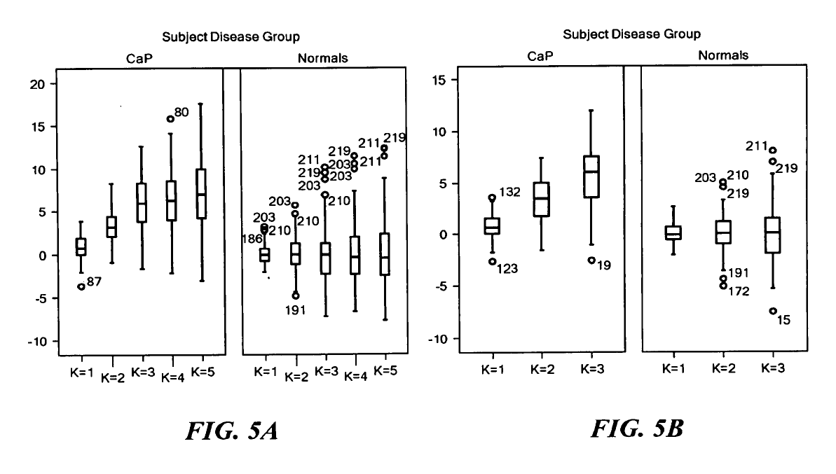

FIG. 4B illustrates the results from a 2-component model based on the prime gene CD97 and the associated proxy gene SP1 where Logit.2(Z) is plotted on the vertical axis. This plot shows that the average cancer case is predicted to be exp(0.53)=1.7 times as likely to be in the Z=1 (cancer) group than the average normal cases. The quantities 0.53 and 1.7 are examples of the average model performance statistic (AMPS) referred to below in sections A(4) of paragraph [0070] and B(5) of paragraph [0071]. Formally, we have:

$$\begin{matrix}Logit .2 ( Z ) = α + {β}_{1} CD 97 + {β}_{2} SP 1 \\ = {β}_{1} [ CD 97 - ( a + bSP 1 ) ]\end{matrix}$$

The second equality above assumes that SP1 is a pure proxy gene for the prime gene CD97 which means that the composite weight β₂ functions in the first equation solely to predict CD97. Prediction of CD97 is obtained from the normal regression line shown in FIGS. 4A and 4B. More generally, when the outcome variable is ordinal or continuous, as a preferred embodiment the mean value for Logit.K(Z) is set equal to 0 for some reference group defined as a subset of the cases. For example, the reference group may be cases scoring in the lowest (highest) P-percentile (e.g., 50th percentile) on Logit.K(Z), in which case Logit.K(Z) and exp[Logit.K(Z)] become more general AMP statistics than for a dichotomous outcome variable described above.

I will also define the standardized composite weight β_{g}* which calibrates the β_{g} to place them on a common standard deviation unit scale, such that the odds in favor of an outcome score Z=1 is exp(β_{g}*) times as high for a case whose Y_{g} value is 1 standard deviation higher than another case having the same values on the remaining G−1 constituents.

An approach for obtaining reliable estimates for the β_{g} weights is not at all obvious. Traditional logistic regression and discriminant analysis approaches both result in weighted sums of the G predictors where the weights are interpretable as log-odds ratios, but neither of these approaches can estimate the weights at all when G>N, and they result in extremely unreliable predictions for large values of G. Our approach exploits properties of the central limit theorem implicitly to reduce the prediction error since the approach involves an averaging of multiple predictions. In particular, predictions obtained from a 1-component model correspond to a weighted average (or weighted sum) of G separate 1-variable predictions for the outcome score. Thus, when the first component is derived according to FIG. 1 (described below), 1-component model predictions have low error rates. Our approach also includes statistics which assist in determining whether additional components are needed to improve predictions by a significant amount over those obtained from a 1-component model.

Although it is common industry practice to select from a large number of potential predictors only those that individually are predictive of the outcome variable(s), we have surprisingly found that a second component can be constructed that usefully enhances prediction when combined with the first component even though the second component by itself is not highly predictive of the outcome variable. The second component in various embodiments of the invention is extracted in a manner similar to the first to have low error. In particular, the 2^{nd} component is correlated with the first, enhancing prediction of the outcome variable obtained from the first component alone by suppressing irrelevant sources of variation from the first component. For example, the correlation between components 1 and 2 in the model described in Table 1A is −0.77. We take advantage of a concept known in other contexts in the statistics literature that suppressor variables can be used to improve prediction greatly by not predicting the outcome scores directly, but by removing irrelevant variation from 1 or more predictors in a model (Horst, 1941; Lynn, 2003; Friedman and Wall, 2005)). The 2^{nd} component used in embodiments herein can be viewed as primarily a construction of suppressor variables. An alternative description of embodiments of the invention herein is provided in my as yet unpublished article attached hereto and incorporated herein by reference as Appendix A and entitled “A Fast Parsimonious Maximum Likelihood Approach for Predicting Categorical and Continuous Outcome Variables from a Large Number of Predictors”.

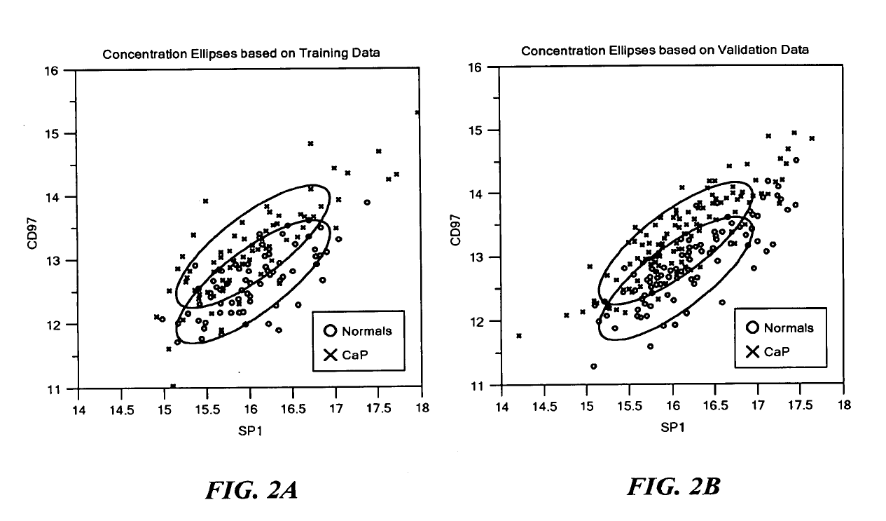

FIG. 1 is a diagram of computer processes used to implement an embodiment of the present invention. One embodiment has been implemented in software developed in the R environment for statistical computing, available at http://www.r-project.org/. The software runs as an application on a digital computer using a Microsoft Windows XP and Vista operating environments, although the selection of these operating systems is simply a matter of design choice. Output from different embodiments obtained from this implementation are provided in Tables 1A, 1B, 2, 3A, 3B, 4, 5, 6A, 10 and FIGS. 2A, 2A, 3A, 3B, 4A, 4B, 5A, 5B, 6, 7A, 7B, and 10A and 10B. We have assumed in FIG. 1 a single outcome variable Z, which is either dichotomous or ordinal with a specified score for each category, G constituents and no covariates, and utilizing approach A1 to implement the “sequentially-independent manner” as described in paragraph [0050]. In this embodiment, the processes include the following:

A. Extract First Component (k=1)
(1) In process 11, perform G linear regressions to determine raw (unstandardized) and also standardized loadings for component k=1. In process 111, compute p-values for each loading in this first component and an overall p-value for the component weight itself. The p-values and the unstandardized loadings for the first component of an 8-gene model are illustrated in table 2 below. In this process, the application calls, for each predictor G, a least-squares fitting procedure. In the R system, this accomplished by binding the predictor values into a matrix to form the y matrix and calling the lm function with the x matrix formed from the dependent variable. The application obtains the unstandardized loadings by applying the appropriate adjustment, as described in paragraph [00127], to the resulting regression coefficients. Under the assumed conditions of FIG. 1 which include a categorical outcome variable and approach A1 to implement the “sequentially independent manner”, the appropriate adjustment is to divide the resulting regression coefficients by the mean square error. (In the case of a continuous outcome variable where approach A2 is used to implement the “sequentially independent manner”, as further described in paragraph [00130] no adjustment is required, the resulting regression coefficients being the unstandardized loadings). For the lm function, the coefficient is selected from the returned “coefficients” matrix; the mean squared error is obtained by summing the squares of the residuals and dividing by the model degrees of freedom.
(2) In process 12, multiply the raw and standardized loadings obtained in process 11 by a component weight b to obtain raw (unstandardized) and standardized composite weights (illustrated in Table 1B below). As a preferred embodiment, the loadings are determined such that b=1 so that the composite weights are equal to the corresponding loadings as shown in Tables 1A and 1B below. The application implements these processes by computing a preliminary composite variable S₀ by computing a weighted sum of the predictor variables, using the estimates for the loadings as initial weights. The obtained result is then regressed against the dependent variable. The regression coefficient is then divided by the mean squared error and multiplied by the original estimated loadings to obtain the updated estimated in process 11. This process is described in more detail in paragraphs [00100]-[00102].
(3) In process 13, compute the predicted score obtained from the 1-component model Logit.1(Z)=b*S₁ where S₁ denotes the first component, S₁ᵢ representing the score on the first component by case i=1, 2, . . . , N. In the application, the process is implemented by computing Logit.1 by a simple matrix multiplication of the N×G predictor matrix by the G×1 vector resulting from process 12.
(4) Optionally, compute a prediction performance measure for the K=1 component model (if validation data exists, compute prediction performance measures for both training and validation cases) (for example, see Tables 3A and 3B below) where both unstandardized and standardized versions of the AMP statistics are shown.
   B. Extract Second Component (k=2)
(1) In process 14 of FIG. 1 (wherein k=2 is a special case), perform G linear regressions to determine raw and standardized loadings for component k=2. In process 111, compute, incremental p-values for components weights associated with components k=1 and k=2 simultaneously. If the p-value associated with component k=2 is greater than accepted criteria (e.g., 0.05), skip to D. Process 111 is implemented in the application by obtaining component p-values via a traditional F-statistic output by standard linear regression packages, the F-statistic being computed as the square of a “dependent effect” divided by the mean squared error. The p-value can then be obtained by standard probability functions. Process 14 in the application obtains the loadings for component k (where k=2 and greater) by performing a regression with the Y matrix formed from the predictors; the X matrix consists of the existing k−1 components and the dependent variable. The loadings are obtained as before from the coefficient matrix and the mean squared error. The loadings are collected in columns. The application computes a preliminary weight by multiplying these loadings with the formed predictor Y matrix, and then appends the weight to the existing k−1 columns of weights.
(2) In process 15 (again wherein k=2 is a special case), determine component weights for components 1 through k=2, denoted b_{1.2} and b_{2.1}. See Table 1B for component weights obtained in a 2-component model and component weights obtained in a 3-component model. One way to estimate the component weights is to perform a regression of the outcome variable Z on the components S₁, S₂, . . . , Sₖ. The preferred embodiment implements process 15 by performing k linear regressions, where the kth such regression regresses Sₖ on the outcome variable plus the remaining k−1 component variables, and adjusting the resulting regression coefficient obtained for the outcome variable by dividing by the mean squared error. This adjusted coefficient is the component weight for the component used as the dependent variable in the associated regression. Thus, the Y response is at each step the k′th column of the weights. The X matrix consists of all weight columns except the k′th weight and the dependent variable. The k coefficients obtained in the usual manner are collected by row.
(3) In process 16 (again wherein k=2 is a special case), obtain raw and standardized composite weights for all components from 1 through component k=2. Each composite weight (for each constituent) is determined by summing, over all components from 1 through component k, the product of the constituent's loading in each component and the corresponding component weight for such component. See Table 1B for a numerical example illustrating the calculation of these component weights. In the application, process 16 is implemented straightforwardly by adjusting the loadings collected in process 14 by the values obtained via process 15. The adjusted loadings are then used to compute new weights.
(4) In process 17 (wherein k=2 is a special case), compute scores each case i for the second component, S₂ᵢ, from the loadings as shown in eq. (5) and compute Logit.2(Z), the predicted outcome values obtained from the K=2 component model, as shown in eq. (6). In process 17 in the application, the k predicted outcome variables, Logit.k′, k′=1, 2, . . . , k are computed by multiplying the existing predictor matrix and the weights from process 16. Standardized logits are obtained by multiplying the unstandardized values by the standard deviations of the predictors.
(5) Optionally, compute a prediction performance measure for the K=2 component model (if validation data exists, compute performance measures for both training and validation cases).
   C. Extract Next Component (k′=k+1)
(1) In process 14, perform G linear regressions to determine raw and standardized loadings for component k. See Table 1A for an example of a 4-component model where none of the 8 constituents have statistically significant loadings on the 4^{th} component (significant loadings are highlighted) and the p-value for the 4^{th} component itself is also nonsignificant (greater than 0.05).
(2) In process 15, obtain component weights and p-values for all components up through component k. Table 1A provides an example where the component weight for components 1, 2, and 3 are statistically significant but the weight for the 4^{th} component is not significant (p=0.08). This 8-gene model was obtained during step 15 of the reduction algorithm described below. Table 4 shows that for the 3-component model, all 3 p-values are significant but for the 4-component model, the p-value associated with the 4^{th} component is not significant.
(3) In process 16, obtain raw and standardized component weights for all components up through k (for a numerical example illustrating the calculation of these component weights for k=2 and k=3 see Table 1B). Optionally, in process 111, compute incremental p-values for components k=1, 2, . . . , k′. If the p-value for any component is greater than accepted criteria (e.g., 0.05), skip to D.
(4) In process 17, compute scores for component S_{k′} and predicted scores Logit.K(Z) based on all components, S₁ up through S_{k′}, as illustrated in eq (6) for the 2-component model.
(5) Optionally, compute the model performance statistic for the K=k′ component model (if validation data exists, compute AMPS for both training and validation samples). For example see Tables 3A and 3B for AMPS associated with K-component models for K=1, 2, 3, 4 and 5. A boxplot showing how the performance measure changes as K increases from K=1 to K=5 based on the validation case is shown in FIG. 5B for the 8-gene model and in FIG. 5A for the 22-gene model.
(6) In process 18, determine whether k=K*+1, and if not loop back to process 14, described above as item (C)1. As one embodiment, K* is selected to be the smallest value for which the component weights for all components S₁ through S_{K*} are statistically significant. We would then examine the prediction performance of the K*-component model. In order to determine K* by this criteria it is necessary to extract K*+1 components and observe that the component weights for at least one of the K*+1 components in the associated K*+1-component model are not statistically significant.
As an alternative embodiment, select K* to be such that the AMPS obtained for in the validation case begins to level off. Note that as evident in FIG. 5A by the increasing vertical length of the boxes in the boxplot as the number of components are increased from 3 to 4 to 5, the variance of the predicted scores increases as the number of components increase. Thus, even though the predictive performance may improve when the number of components is increased—as indicated in FIG. 5A by the increase in the mean as the number of components are increased, (black bar within the box rises as the number of components increase in the left-most figures) the number of false positives and false negatives may also increase.
If k=K*+1, then in process 19, optionally reduce the number of predictors (as illustrated in Table 3A and Table 4 and described further below) to G* constituents (in the case of no covariates) and optionally reduce the number of components (as illustrated in Table 3A and Table 4 and described further below where we see that reducing the number of predictors to 2 results in the model based on the constituents CD97 and SP1). Thus it is possible in the application to reduce automatically the number of components by invoking process 111 at an appropriate point in process 14: if the resulting p-value is above some cutoff, the sequence of adding the k loadings is halted. It is possible in the application to automatically reduce the number of predictors. For example, the predictor to be eliminated may be selected as the one with the smallest absolute standardized composite weight. In one embodiment, the application selects a particular value for K and considers the standardized composite weights for all constituents in the K-component model. This process continues examining the K-component model so long as all K component weights are statistically significant. If one or more are non-significant (by default at the 0.05 level), K is reduced by 1 and the standardized coefficients in the K−1-component model are examined, as long as K−1 component weights are significant. This process continues until some termination criterion is satisfied, such as (1) the number of predictors in model G* is reached, or (2) the performance measure falls below a pre-specified level, etc. Thereafter in process 112, the completed model is provided as an output.

Embodiments of the invention described above have remarkable applicability to gene expression data. In modeling gene expression data in accordance with the procedure described above in connection with FIG. 1, the first component includes constituents (identified as those having statistically significant loadings) that are determined to be most predictive individually of the outcome variable. We call these constituents “prime” genes. In the second component however, and remarkably, we have found constituents that are not themselves significantly predictive of the outcome variable, that are highly correlated with one or more prime genes, yet when included in the model significantly enhance the prediction of the outcome variable. Such genes in the second component we call “proxy” genes. Although we have used purely statistical methods in accordance with embodiments of the present invention to identify constituents in the first and second components, nevertheless, it appears that the prime and proxy genes have biological significance. We discuss these aspects in connection with FIGS. 2A and 2B, 3A and 3B, and 4A and 4B.

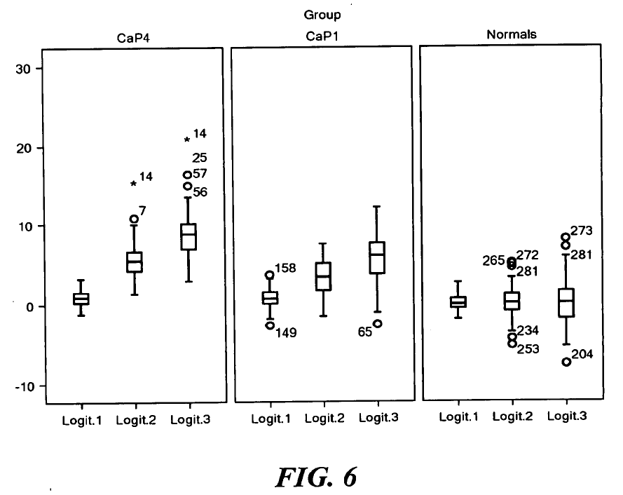

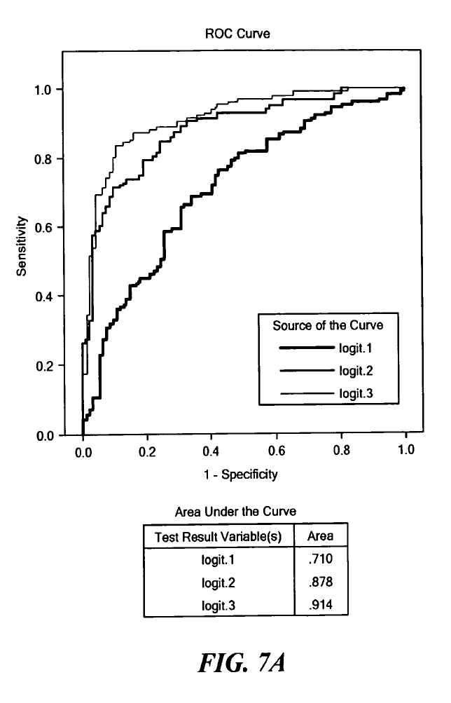

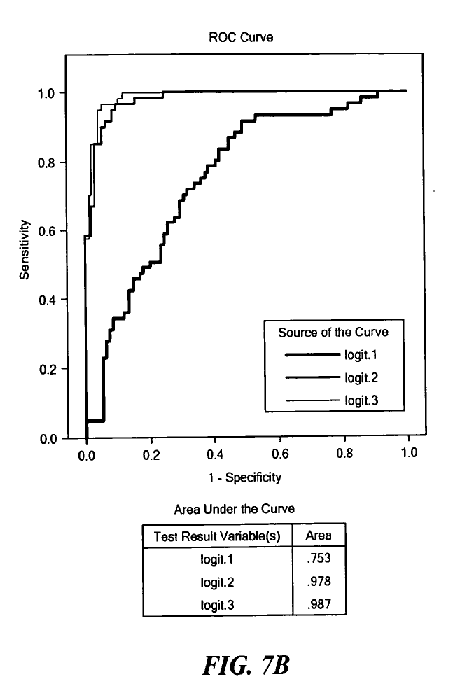

When the 8-gene model obtained in the training dataset was applied to an independent validation data set, the predictive performance measures indicated that prediction based on the 3-component model was very strong. This is shown in Table 5A (for the training cases) and Table 5B (for the validation cases), and shown graphically in FIG. 5B for the validation data, providing good separation between cases with Prostate cancer from normal cases. Surprisingly, predictions obtained from application of this same model to those with late stage prostate cancer were found to perform even better, achieving very good separation between the late stage cancer cases and normals as shown in Table 6, FIGS. 6, 7A and 7B. Generally, when a model where the coefficients are estimated on some set of data is applied to another set of data there is some falloff in prediction, as occurs for example when a model developed on training cases is applied to validation (holdout) samples. It is extremely rare that a model actually performs better on some other population. This result is consistent with the predictions Logit.3(Z) representing a measure of the underlying biological condition, the condition apparently worsening for late stage cancer cases. FIG. 7B shows that the area under the curve (AUC) increases from 0.914 for CaP1 to 0.987 for CaP4. FIG. 6 is a boxplot showing results from the validation.

TABLE 6

| | 3-component model results | |
|---|---|---|
| | obtained when model Is | |
| | applied to the validation data | |
| | CaP1 vs. | CaP4 vs. |
| | Norms | Norms |
| AUC (Area under the ROC curve) | 0.91 | 0.98 |
| AMPS** | 5.54 | 8.75 |
| Sensitivity* | 85.16 | 93.55 |
| Specificity* | 85.11 | 94.68 |
| *cutoff = | 2.51 | 3.94 |
| **Average Model Performance Statistic | | |
| N = | | |
| CaP1 (early stage prostate cancer) | 128 | |
| CaP4 (late stage prostate cancer) | 62 | |
| Normals | 94 | |

If a common cutoff is used, determined from the training sample, then specificity above will be the same and sensitivity for CaP4 will increase to 100% (all 61 CaP4 subjects are correctly classified). Currently, the table shows separate cutoffs determined from validation and CaP4 data separately.

The data suggest that the outcome variable—which is an observable biological condition of a subject (for example, normal or prostate cancer), even though it may be categorical—nevertheless contains information relating to a more fundamental latent underlying continuous variable describing condition, which is determined in our model as the continuous predicted score logit.K(Z). In this respect the predicted score obtained from embodiments of our model is a more rigorous index of biological condition than the outcome variable itself. Furthermore, the predicted score obtained from our model is a more rigorous version of the index of biological condition based on gene expression measurements described in U.S. Pat. No. 6,964,850, which is hereby incorporated herein by reference. Accordingly, the predicted score obtained from embodiments of our model may be used (i) to explore the effect of varying doses, including concentrations and timing, for compounds in development or for compounds to be tested in human and non-human subjects and therefore to optimize dosage for all or particular types of cases; (ii) to monitor changes and effects associated with different therapies of all kinds, including administration of drugs and complex substances alone or in combinations and in varying concentrations and timing for purposes including determination of efficacy, safety, or mode of physiological action as well as development of individualized therapies; and (iii) monitoring progress of a specific disease in subjects as well as determining the stage of a disease, such as a cancer.

FIGS. 2A and 2B are plots of prime gene expression values (of CD97) on the vertical axis versus proxy gene expression values (of SP1) on the horizontal axis in training data and validation data respectively in normal subjects, represented by small circle data points (in blue in the original figures), and in prostate cancer subjects, represented by small square data points (in red in the original figures), and wherein most normal subjects are contained in the lower (blue) ellipse and most prostate cancer subjects are contained in the upper (red) ellipse.

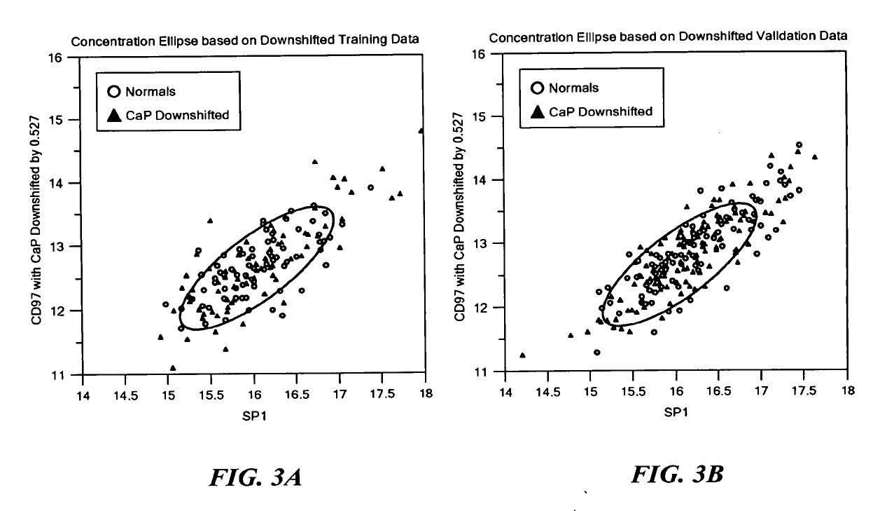

FIGS. 3A and 3B are also plots of prime gene expression values (of CD97) versus proxy gene expression values (of SP1) in training data and validation data respectively in normal subjects, represented by small circle data points (in blue in the original figures), and in prostate cancer subjects, represented by small triangular data points (in red in the original figures). In these figures, however, the actual gene expression values for the gene CD97 are downshifted by 0.53* ct, with result that the ellipses for both normal and prostate cancer subjects are coincidental for both training data and validation data.

FIGS. 4A and 4B are similar plots of prime gene expression values (of CD97) versus proxy gene expression values (of SP1) in training data and validation data respectively in normal subjects, represented by small circle data points (in blue in the original figures), and in prostate cancer subjects, represented by small square data points (in red in the original figures). In FIG. 4A, the data are exactly the same as in FIG. 2A, whereas in FIG. 4B, the actual gene expression values for the gene CD97 for each case are shifted by a predicted value for CD97 given the value of SP1 for normal subjects in the two-gene model of FIG. 4A. The plot shows precisely that for normal subjects the mean value on the adjusted CD97 score is 0 and that for prostate cancer cases, the adjusted C97 score is elevated over the mean value for normals.

One understanding of the significance of FIGS. 4A and 4B is that the SP1 gene acts as a good proxy for the value of CD97 in the same subject when the subject is normal, so that when the value of SP1 gene is subtracted from the value of the CD97 gene (subject to multiplication by the appropriate weights in the model), one has a better prediction of the outcome variable than by using the CD97 value by itself. In fact, SP1 is a transcription factor that [is?] implicated in regulation of CD97. See Wobus et al., Transcriptional regulation of the human CD97 promoter by Sp1/Sp3 in smooth muscle cells, Gene 413: Issues 1-2, 30 Apr. 2008, 67-75.

When the predictors are gene expression measurements, as we will demonstrate, prediction from a single expression that differs between cancer and normal cases (for a ‘prime gene’) can be enhanced substantially by subtracting out what might be viewed as a prediction of the pre-cancer value for that gene (obtained from a ‘proxy gene’ whose expression does not differ between cancer and normal cases), thus converting the effect of the expression of the prime gene to a larger effect of the predicted ‘change in expression’ from the prime gene. This is illustrated graphically in FIGS. 2A, 2B, 3A, and 3B.

The 3^{rd} (k′=3) and further components (k′=4, 5, . . . , K) are extracted sequentially, until further improvement by extracting additional segments is small (and not statistically significant) over predictions based solely on the components extracted previously (k=1, 2, . . . , k′−1).

In the case that the data contains no suppressor variables, the approach may terminate after extracting the first component only. Termination after a single component has not occurred in our analyses of gene expression data to date as suppressor variables appear to be prevalent in the gene expression data we have analyzed. Typically, good prediction is obtained after only 3-5 components are extracted.

In a K-component model, parameters (coefficients) representing the contribution of each predictor on each component, ‘loadings’, as well as parameters (coefficients) representing the overall contribution of each predictor in the K-component model, ‘weights’, are obtained.

I initially believed that since the number of total parameters (G+K) in the K-component model is large (G loadings for each of the K components plus K additional component weights to obtain an optimal linear combination of the components), the resulting model might overfit the training case and thus not validation well on an independent validate sample. However, I was surprised to find that in fact the models validated extremely well.

Table 1A shows standardized loadings for each of 8 predictors, and p-values, p(k), associated with each of the 4 components in a 4-component model. The p-values show that only the first 3 components are statistically significant at the 0.05 level. For component #1, 4 constituents have statistically significant loadings (these ‘prime genes’ are color coded below). Pure suppressor variables (‘proxy genes’) can be identified as those which do not ‘load’ significantly on component 1 but are significant on component 2. For component #2, five predictors are statistically significant, 4 of which are not statistically significant in component #1 (these 4 loadings are color coded green and are associated with the ‘proxy genes’). Three predictors that are significant in component #1 (prime genes, color coded blue) are not statistically significant in component #2. Table 1B shows the standardized weights for each gene in a 1-component model, a 2-component model, a 3-component model, and a 4-component model. Notice that the weights associated with the suppressor variables (highlighted in green) increase in magnitude as K increases from 1 to 2 to 3. The same is true for the prime effects (highlighted in blue).

TABLE 1A
Component weights and p-values in models for K = 3,4 and
Standardized Loadings associated with each
Component in a 4-component/8-constituent model

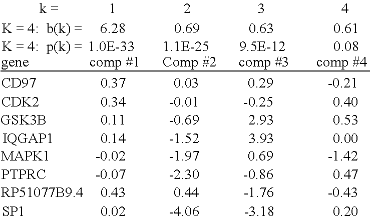

TABLE 1B
Standardized Composite Weights for the 8 Constituents
in the K-component Models, for K = 1,2,3

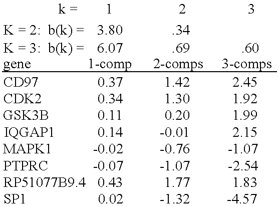

For constituent CD97 the computations for the standardized component weights for the 2-component and 3-component models are given below where the appropriate quantities are obtained from Tables 1A and 2A:

K=2: (3.80)*(0.37)+(0.34)*(0.03)=1.42

K=3: (6.07)*(0.37)+(0.69)*(0.03)+(0.60)*(0.29)=2.45

I then realized that despite the large number of total parameters, the K-component model is actually more parsimonious than the traditional logistic regression model that has fewer total parameters. For example, in the case of a small number of genes (say G=4), it can be shown that a 4-component model provides asymptotically equivalent weight estimates to those to obtained by maximum likelihood estimation in traditional logistic regression analysis. With G=4, a K=3 component model is thus more parsimonious than a logistic regression model since the latter is asymptotically equivalent to a 4-component model! Since it is not possible to obtain more than G components, typically a good fitting model results with fewer than G components. In traditional logistic regression and discriminant analysis, it is not possible to reduce the number of components to obtain more parsimonious results because those approaches do not utilize components at all. In logistic and linear regression, the more predictors included in a model the greater the chance for overfitting and the greater the amount of fall-off when applied to validation data. With the current approach, the more predictors included in a model the lower the error since components are based on an average of a larger number of effect estimates and hence the smaller the expected falloff when applied to validation data.

Relevant statistical tests are derived here for our K-component models. Such are not available for prior art K-component models. For example, PLS regression, which has been proposed as a substitute for linear regression, has no statistical tests associated with it. Approaches have been proposed for extending PLS regression to the logistic regression situation where the outcome is dichotomous (Marx, 1996; Ding and Gentleman, 2005; Fort, and Lambert-Lacroix, 2003) but statistical tests are not available to help determine the number of components for those approaches. In addition, those approaches estimate the weights using iterative approximations, while our approach provides exact closed-form estimates for the weights. Finally, prediction achieved by our approach tends to be better and is achieved with fewer components than PLS regression. In particular, the ^{2nd} component in PLS regression is extracted so that it is uncorrelated with the first component. This dilutes the powerful improvement we have discovered that can result from the inclusion of suppressor variables and thus PLS regression results in more components than needed to provide good prediction.

My approach employs the concept of sequential independence. For a categorical outcome variable Z, each Y_{g} is used, one at a time, as a dependent variable and regressed on Z plus the components that have been previously extracted. Under the assumption of normally distributed errors, this approach (described in full detail below) results in estimates that can be used to obtain maximum likelihood estimates for the weights (Lyles, 2009). Additional important benefits from this approach include improved speed—we obtain maximum likelihood estimates with closed form expressions directly, we avoid time-consuming iterative approaches, missing data issues can be handled in a straight-forward way, and the model can more easily be generalized to handle multiple outcome variables (see paragraph [00115]) as well as estimating category scores for outcome variables with J>2 categories outcomes when the relative spacing between the outcome categories is unknown (see also paragraph [00115]).

For a continuous outcome variable a similar approach allows development of the K-component models, which represent a parsimonious alternative to traditional linear regression in the case of many predictor variables (see paragraph [00130]). Each of these extensions is detailed below.

A fast variable reduction algorithm can be employed following model development that reduces the number of variables in the K-component model to retain a high percentage of the predictive power with only a subset of the G predictors. Statistics are available to remove the appropriate variables, one or more at a time, that contribute least in the model. This algorithm can be used with specialized design criteria to obtain, say, the best model containing G* variables, where G* is a design parameter. Another use of the model is to improve the predictive performance of an existing model, by including it as another predictor variable in the model, and force it to remain in the model throughout the variable reduction step. Variable reduction approaches have been suggested in the literature, but none are fully integrated with the model development and hence are sub-optimal due to different assumptions being made than those for model development. We discuss this topic in further detail beginning in paragraph [00142] below.

As one embodiment, the absolute value of the standardized weight associated with a particular outcome variable, |β_{g}*|, is used as the measure of variable importance, which assesses the importance of the gth predictor variable in predicting that outcome variable. In the case of more than 1 outcome variables, a weighted average of separate |β_{g}*| associated with each outcome variable can be used for variable reduction. As another embodiment, a weighted sum of squares can be used where separate β_{g}*², one associated with each outcome variable, is assigned a weight. One benefit of using a single variable reduction strategy across multiple outcome variables is to obtain a relatively small common pool of constituents that can be used for possibly separate models developed for each outcome variable.

The statistics literature contains various proposed measures of variable importance, but each has been shown to be problematic. An article in the current issue of the American Statistician states: “Relative importance of regression variables is an old topic that still awaits a satisfactory solution” . . . Gromping, 2009. I believe that measures based on β_{g}* when used in conjunction with K-component models offer a good resolution to this long-standing problem.

Tables 3A and 3B summarize the results of applying the variable reduction method beginning with 22 genes for the prostate cancer vs. normals data used earlier. Note that the model with 8 constituents remaining was the same model illustrated earlier (Table 2). Table 4 presents the p-values for each step, the non-significant p-values highlighted. Note the following results:
In step 0 where all 22 gene expression variables are retained as predictors in the model, the 6^{th} component is not significant.
At each step we examine the standardized composite weight associated with the K*=4-component model and eliminate the predictor having the best absolute value.
After step r, there are 22-r predictors remaining in the model. For example, after step r=14, there are 8 predictors remaining in the model.
For the 8-constituent/4-component model, the 4^{th} component is seen to be nonsignificant (highlighted p-value=0.0760). Thus, for the 8-constituent model, for steps r>13 we change K* from 4 to K*=3 (i.e., we would refer to the 3-component model to determine the next predictor to remove).
Table 3A shows that AMPS=6.57 in the training data and 5.54 in the validation data for this model. AMPS=5.54 means that the average cancer subject in the validation data set has odds of exp(5.54)=255 times as high as the average normal case of being predicted by the 8-constituent/3-component model to have cancer, a strong validation of this model.

TABLE 3A

| | | | AMPS.K(Z) obtained from | | | | |
|---|---|---|---|---|---|---|---|
| | | # | Training Data | | | | |
| | Constituent | constituents | # Components K | | | | |
| Step | Removed | remaining | 1 | 2 | 3 | 4 | 5 |
| 0 | None | 22 | 1.36 | 4.13 | 7.43 | 8.79 | 9.48 |
| 1 | C1QA | 21 | 1.37 | 4.20 | 7.24 | 8.61 | 9.27 |
| 2 | ST14 | 20 | 1.38 | 4.16 | 7.01 | 8.32 | 8.86 |
| 3 | S100A6 | 19 | 1.34 | 4.19 | 7.02 | 8.29 | 8.85 |
| 4 | TNF | 18 | 1.37 | 4.19 | 6.98 | 8.15 | 8.69 |
| 5 | SMAD3 | 17 | 1.49 | 4.09 | 7.42 | 8.31 | 8.72 |
| 6 | MYC | 16 | 1.55 | 3.94 | 7.78 | 8.47 | |
| 7 | RB1 | 15 | 1.52 | 4.11 | 7.54 | 8.39 | |
| 8 | IL18 | 14 | 1.33 | 4.21 | 7.20 | 8.05 | |
| 9 | ABL1 | 13 | 1.32 | 4.27 | 7.27 | 8.11 | |
| 10 | CCNE1 | 12 | 1.26 | 4.27 | 7.00 | 7.74 | |
| 11 | BRCA1 | 11 | 1.13 | 4.26 | 6.93 | 7.64 | |
| 12 | MAP2K1 | 10 | 1.20 | 4.04 | 6.85 | 7.58 | |
| 13 | TP53 | 9 | 1.36 | 4.02 | 6.81 | 7.44 | |
| 14 | CDKN2A | 8 | 1.02 | 3.88 | 6.57 | | |
| 15 | MAPK1 | 7 | 0.99 | 3.92 | 6.06 | | |
| 16 | GSK3B | 6 | 1.07 | 3.79 | 5.39 | | |
| 17 | RP51077B9.4 | 5 | 0.90 | 3.57 | 4.64 | | |
| 18 | PTPRC | 4 | 0.73 | 2.85 | | | |
| 19 | IQGAP1 | 3 | 0.87 | 3.01 | | | |
| 20 | CDK2 | 2 | | | | | |

Final 2-gene Model: CD97/SP1

TABLE 3B

| | | | AMPS.K(Z) obtained from | | | | |
|---|---|---|---|---|---|---|---|
| | | # | Validation Data | | | | |
| | constituent | constituents | # Components K | | | | |
| Step | Removed | remaining | 1 | 2 | 3 | 4 | 5 |
| 0 | None | 22 | 0.82 | 3.20 | 5.88 | 6.36 | 6.93 |
| 1 | C1QA | 21 | 0.83 | 3.24 | 5.72 | 6.17 | 6.67 |
| 2 | ST14 | 20 | 0.84 | 3.21 | 5.56 | 5.99 | 6.43 |
| 3 | S100A6 | 19 | 0.81 | 3.26 | 5.58 | 5.99 | 6.46 |
| 4 | TNF | 18 | 0.85 | 3.33 | 5.62 | 5.99 | 6.46 |
| 5 | SMAD3 | 17 | 0.95 | 3.22 | 5.94 | 6.10 | 6.48 |
| 6 | MYC | 16 | 1.01 | 3.04 | 6.04 | 6.07 | |
| 7 | RB1 | 15 | 0.98 | 3.14 | 6.04 | 6.12 | |
| 8 | IL18 | 14 | 0.82 | 3.07 | 5.73 | 5.87 | |
| 9 | ABL1 | 13 | 0.81 | 3.11 | 5.81 | 5.90 | |
| 10 | CCNE1 | 12 | 0.81 | 3.23 | 5.61 | 5.61 | |
| 11 | BRCA1 | 11 | 0.70 | 3.16 | 5.45 | 5.46 | |
| 12 | MAP2K1 | 10 | 0.75 | 2.97 | 5.40 | 5.46 | |
| 13 | TP53 | 9 | 0.87 | 2.93 | 5.36 | 5.46 | |
| 14 | CDKN2A | 8 | 0.76 | 3.35 | 5.54 | | |
| 15 | MAPK1 | 7 | 0.73 | 3.58 | 5.32 | | |
| 16 | GSK3B | 6 | 0.84 | 3.51 | 5.20 | | |
| 17 | RP51077B9.4 | 5 | 0.63 | 3.01 | 4.28 | | |
| 18 | PTPRC | 4 | 0.49 | 2.24 | | | |
| 19 | IQGAP1 | 3 | 0.57 | 2.42 | | | |
| 20 | CDK2 | 2 | | | | | |

Final Model: CD97/SP1

TABLE 4
Results obtained from Training Data at each step of the Reduction Algorithm
Criteria: For K* = 4, constituent with lowest abs(standardized beta) is removed at each step

| | | | Incremental p-values for components | | | | | |
|---|---|---|---|---|---|---|---|---|
| | | | k = 1, 2, 3, 4, 5 | | | | | |
| | constituent | | Component # k | | | | | |
| Step | removed | # Vars remaining | 1 | 2 | 3 | 4 | 5 | 6 |

| | | |
|---|---|---|
| 1 | None | 22 |

| | | | | | | |
|---|---|---|---|---|---|---|
| K = 1 components | 3.1E−11 | | | | | |
| K = 2 components | 8.0E−25 | 2.0E−15 | | | | |
| K = 3 components | 7.0E−36 | 7.7E−26 | 8.1E−13 | | | |
| K = 4 components | 1.5E−37 | 1.9E−29 | 1.5E−16 | 3.1E−05 | | |
| K = 5 components | 6.7E−37 | 8.1E−29 | 6.1E−17 | 4.6E−07 | 0.0037 | |
| K = 6 components | 7.9E−34 | 1.2E−24 | 1.1E−16 | 1.6E−07 | 0.0010 | 0.1187 |

| | | |
|---|---|---|
| 2 | C1QA | 21 |

| | | | | | | |
|---|---|---|---|---|---|---|
| K = 1 components | 2.5E−11 | | | | | |
| K = 2 components | 4.5E−25 | 1.3E−15 | | | | |
| K = 3 components | 2.5E−35 | 3.1E−25 | 5.3E−12 | | | |
| K = 4 components | 3.1E−37 | 6.1E−29 | 8.0E−16 | 2.6E−05 | | |
| K = 5 components | 5.8E−36 | 1.4E−28 | 1.2E−16 | 4.5E−07 | 0.0043 | |
| K = 6 components | 2.7E−33 | 3.7E−23 | 5.0E−16 | 1.5E−07 | 0.0012 | 0.1163 |

| | | |
|---|---|---|
| 3 | ST14 | 20 |

| | | | | | | |
|---|---|---|---|---|---|---|
| K = 1 components | 2.1E−11 | | | | | |
| K = 2 components | 6.9E−25 | 2.4E−15 | | | | |
| K = 3 components | 1.3E−34 | 1.6E−24 | 1.8E−11 | | | |
| K = 4 components | 1.9E−36 | 3.8E−28 | 3.1E−15 | 3.1E−05 | | |
| K = 5 components | 1.0E−33 | 6.7E−28 | 3.4E−16 | 9.3E−07 | 0.0079 | |
| K = 6 components | 1.2E−32 | 3.0E−22 | 1.5E−15 | 4.7E−07 | 0.0028 | 0.1654 |

| | | |
|---|---|---|
| 4 | S100A6 | 19 |

| | | | | | | |
|---|---|---|---|---|---|---|
| K = 1 components | 3.6E−11 | | | | | |
| K = 2 components | 4.8E−25 | 1.0E−15 | | | | |
| K = 3 components | 1.0E−34 | 9.0E−25 | 2.1E−11 | | | |
| K = 4 components | 3.4E−36 | 3.0E−28 | 5.2E−15 | 4.2E−05 | | |
| K = 5 components | 3.7E−34 | 9.5E−29 | 4.0E−16 | 1.1E−06 | 0.0072 | |
| K = 6 components | 3.3E−32 | 6.6E−22 | 5.3E−15 | 5.5E−07 | 0.0025 | 0.1510 |

| | | |
|---|---|---|
| 5 | TNF | 18 |

| | | | | | | |
|---|---|---|---|---|---|---|
| K = 1 components | 2.5E−11 | | | | | |
| K = 2 components | 4.6E−25 | 1.4E−15 | | | | |
| K = 3 components | 1.4E−34 | 1.8E−24 | 3.0E−11 | | | |
| K = 4 components | 9.6E−36 | 1.0E−27 | 1.3E−14 | 0.0001 | | |
| K = 5 components | 3.3E−33 | 4.6E−28 | 1.2E−15 | 2.2E−06 | 0.0080 | |
| K = 6 components | 2.6E−32 | 3.6E−21 | 5.3E−14 | 1.1E−06 | 0.0030 | 0.1691 |

Starting with kcomp = 4, constituent with lowest abs(standardized beta) is removed at each step

| | | | Incremental p-values for components k = 1, 2, 3, 4, 5 | | | | |
|---|---|---|---|---|---|---|---|
| | | | Components # | | | | |
| Step | constituent removed | # Vars remaining | 1 | 2 | 3 | 4 | 5 |

| | | |
|---|---|---|
| 13 | MAP2K1 | 10 |

| | | | | | |
|---|---|---|---|---|---|
| K = 1 components | 3.1E−10 | | | | |
| K = 2 components | 1.2E−24 | 4.9E−16 | | | |
| K = 3 components | 6.1E−33 | 1.8E−25 | 1.8E−11 | | |
| K = 4 components | 2.9E−33 | 6.7E−25 | 1.2E−13 | 0.0013 | |
| K = 5 components | 2.2E−30 | 9.2E−25 | 1.1E−13 | 0.0007 | 0.2691 |
| K = 6 components | | | | | |

| | | |
|---|---|---|
| 14 | TP53 | 9 |

| | | | | | |
|---|---|---|---|---|---|
| K = 1 components | 3.1E−11 | | | | |
| K = 2 components | 1.4E−24 | 5.7E−15 | | | |
| K = 3 components | 6.6E−32 | 1.1E−24 | 2.0E−11 | | |
| K = 4 components | 1.0E−32 | 8.0E−23 | 3.4E−13 | 0.0026 | |
| K = 5 components | 1.5E−30 | 6.2E−22 | 3.3E−13 | 0.0021 | 0.5008 |
| K = 6 components | | | | | |

| | | |
|---|---|---|
| 15 | CDKN2A | 8 |

| | | | | |
|---|---|---|---|---|
| K = 1 components | 4.5E−09 | | | |
| K = 2 components | 5.0E−24 | 1.6E−16 | | |
| K = 3 components | 2.6E−33 | 4.0E−26 | 2.8E−11 | |
| K = 4 components | 1.0E−33 | 1.1E−25 | 9.5E−12 | 0.0760 |
| K = 5 components | | | | |
| K = 6 components | | | | |

| | | |
|---|---|---|
| 16 | MAPK1 | 7 |

| | | | | |
|---|---|---|---|---|
| K = 1 components | 7.8E−09 | | | |
| K = 2 components | 3.4E−24 | 6.3E−17 | | |
| K = 3 components | 7.6E−32 | 2.5E−24 | 1.9E−09 | |
| K = 4 components | 6.5E−28 | 1.4E−21 | 1.7E−09 | 0.4679 |
| K = 5 components | | | | |
| K = 6 components | | | | |

| | | |
|---|---|---|
| 17 | GSK3B | 6 |

| | | | | |
|---|---|---|---|---|
| K = 1 components | 2.1E−09 | | | |
| K = 2 components | 1.2E−23 | 8.1E−16 | | |
| K = 3 components | 1.5E−29 | 2.2E−20 | 1.0E−07 | |
| K = 4 components | 6.9E−30 | 2.1E−19 | 2.9E−08 | 0.1011 |
| K = 5 components | | | | |
| K = 6 components | | | | |

| | | | Incremental p-values for | | | |
|---|---|---|---|---|---|---|
| | | | components k = 1, 2, 3, 4 | | | |
| | | | Components # | | | |
| Step | constituent removed | # Vars remaining | 1 | 2 | 3 | 4 |

| | | |
|---|---|---|
| 18 | RP51077B9.4 | 5 |

| | | | | |
|---|---|---|---|---|
| K = 1 components | 3.0E−08 | | | |
| K = 2 components | 1.0E−22 | 5.2E−16 | | |
| K = 3 components | 5.5E−26 | 5.2E−17 | 6.9E−06 | |
| K = 4 components | 6.3E−26 | 3.8E−17 | 4.3E−06 | 0.2804 |
| K = 5 components | | | | |
| K = 6 components | | | | |

| | | |
|---|---|---|
| 19 | PTPRC | 4 |

| | | | |
|---|---|---|---|
| K = 1 components | 4.5E−07 | | |
| K = 2 components | 2.0E−19 | 7.4E−14 | |
| K = 3 components | 4.9E−23 | 0.1166 | 3.1E−05 |
| K = 4 components | | | |
| K = 5 components | | | |
| K = 6 components | | | |

| | | |
|---|---|---|
| 20 | IQGAP1 | 3 |

| | | | |
|---|---|---|---|
| K = 1 components | 4.6E−08 | | |
| K = 2 components | 3.5E−20 | 1.2E−13 | |
| K = 3 components | 1.4E−15 | 0.0535 | 0.4276 |
| K = 4 components | | | |
| K = 5 components | | | |
| K = 6 components | | | |

| | | |
|---|---|---|
| 21 | CDK2 | 2 |

| | | |
|---|---|---|
| K = 1 components | 9.3E−07 | |
| K = 2 components | 2.0E−07 | 2.1E−08 |
| K = 3 components | | |
| K = 4 components | | |
| K = 5 components | | |
| K = 6 components | | |

Final model CD97/SP1

The model development and variable reduction method were also applied to fMRI data obtained from 1 subject who was a cocaine addict. This sample observations for this example consisted of measurements on G=3,435 constituents, corresponding to 3,435 voxels from a particular portion of the brain, measured repeatedly over N=360 time points, each time point serving as a case in the analysis. The 360 time points consisted of 12 cycles of 30 time points, the subject being shown a control video (Z=0) during the first half of each cycle followed by a video showing addicts getting high on cocaine (Z=1) during the second half. The first 4 cycles were used as the training data used to develop the K-component models, which were then tested on the last 8 cycles of data. To control for random movements of the subject during the fMRI, the variables were centered prior to beginning the analysis such that the mean on each variable was 0 within each cycle for the subset of time points associated with the control video.

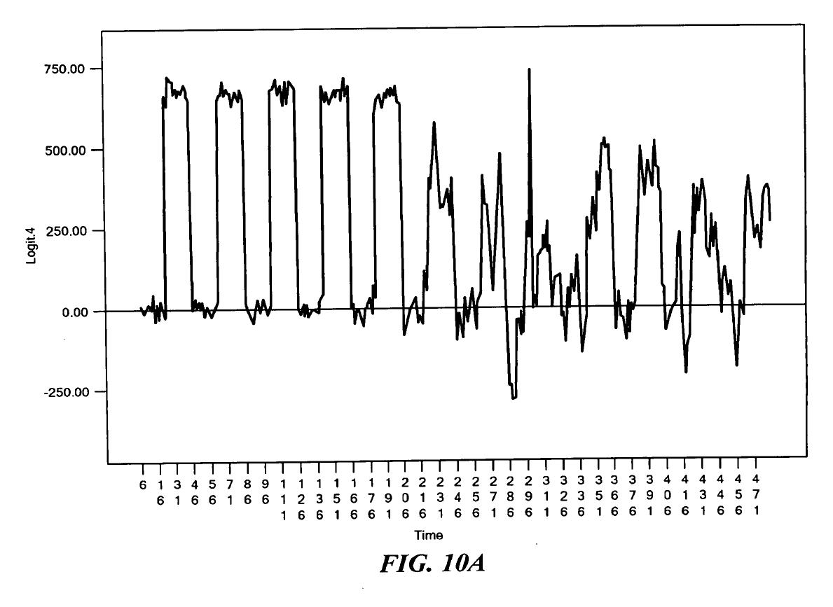

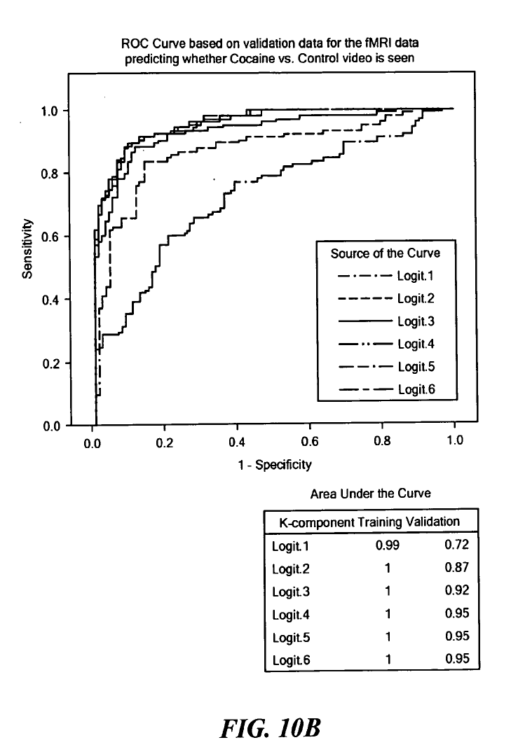

FIGS. 10A and 10B illustrate the results of analysis of the fMRI data using K-component models. Predictions were obtained from 3,445 fMRI brain pixel measurements using the 4-component model, for each of N=360 time points corresponding to 12 cycles, where the 1^{st} 4 cycles were used as the training sample to develop the model and the remaining 8 cycles were used to validate the model. FIG. 10A shows the predicted outcome score Logit.4 plotted as a function of time, where the first 4 time cycles correspond to the training data and the remaining 8 cycles correspond to the validation time points. Each cycle is split into a first half (30 time points) corresponding to when a control video is seen followed by a second half (also 30 time points) corresponding to when a video is seen of people getting high on cocaine. FIG. 10B summarizes the performance of the various K-component models in predicting a dichotomous outcome variable Z, where Z=1 corresponds to the cocaine video time points and Z=0 corresponds to the control video time points. The predicted outcome score obtained from the K-component model is denoted by Logit.K. As the number of components is increased the performance is improved, with Logit.4 being the peak performance and Logit.1 being the weakest performance, according to the validation time points. ROC curves are provided as well as the area under the curve associated with these curves for each K-component model. In the second column of the table shows that prediction of the outcome variable is perfect in the training time points beginning with the 2-component model (area under curve=1) and, surprisingly, despite the fact that there is perfect prediction of the training points with the 2-component model, prediction of validation data shows that model continues to improve for additional components up through the 4-component model (area under curve peaks at 0.95). Table 10 provides performance data for the various K-component models.

TABLE 10
Comparison of performance of K = 1, 2, 3, 4, 5, 6 component models
based on G = 3,435 constituents

| | K = | | | | | |
|---|---|---|---|---|---|---|
| | 1 | 2 | 3 | 4 | 5 | 6 |
| | Model Performance Indices - Training | | | | | |
| AMPS | 5.53 | 36.15 | 185.36 | 671.47 | 2315.09 | 6941.54 |
| AUC | 0.99 | 1.00 | 1.00 | 1.00 | 1.00 | 1.00 |
| | Model Performance Indices - Validation | | | | | |
| AMPS | 1.16 | 15.34 | 79.01 | 293.13 | 997.60 | 2962.08 |
| AUC | 0.72 | 0.87 | 0.92 | 0.95 | 0.95 | 0.95 |

Overall, 18% of the constituents (prime constituents) loaded significantly on the first component showing significantly different patterns during the control and cocaine portions of the design. An additional 6.5% of the constituents (proxy constituents) loaded significantly on the second component but not on the first. The correlation between the first and second components was (−0.63), indicating that these proxy constituent variables were moderately correlated with at least one of the prime variables.

The algorithm for a single outcome Z with J categories, the jth of which has score Z(j), so that Z={Z(1), Z(2), . . . , Z(J)}proceeds as follows:

Step 1: Extract Component k=1

Obtain coefficients for each predictor variable Y_{g} g=1, 2, . . . , G on the k=1^{st} component S₁, such coefficient being called the ‘loading of Y_{g} on S₁’.

A) Perform G univariate linear regressions, the gth of which is the regression of Y_{g} on Z, providing an initial estimate associated with the gth predictor, denoted λ_{g}′⁽⁰⁾:

Y_{g}=α_{g}⁽⁰⁾+λ_{g}′⁽⁰⁾Z+ε_{g}⁽⁰⁾ (1)

We then obtain an initial estimate for the coefficient in the 1-component model λ_{g}⁽⁰⁾ by dividing λ_{g}′⁽⁰⁾ by the mean squared error (MSE):

λ_{g}⁽⁰⁾=λ_{g}′⁽⁰⁾/MSE(ε_{g}⁽⁰⁾) (2)

Under the assumption that the error ε_{g}⁽⁰⁾ is normally distributed, the quantity obtained for λ_{g}⁽⁰⁾ in eq. (2) is the maximum likelihood estimate for the log-odds ratio λ_{g} in the simple logistic regression model Logit(Z)=α_{g}+λ_{g}Y_{g} (Lyles, et. al. 2009). Using the G loadings, λ_{g}⁽⁰⁾, obtained from eq (2) we compute

$${S}_{0} = {\sum }_{g = 1}^{G} {λ}_{g}^{( 0 )} {Y}_{g}$$

as an average (or sum) of these G simple logistic regression model predictions (ignoring the intercept α). Note that the loading λ_{g}⁽⁰⁾ is the maximum likelihood estimate for the partial log-odds ratio in the more general multiple logistic regression model in the special case that all Y_{g} are uncorrelated. The first component S₁ is then obtained as a standardized version of S₀ as follows:

D) Compute the first component Logit.1(Z):

Perform a linear regression of S₀ on Z:

S₀=α₀+b₀′Z+ε₀

Compute: S₁=b₀S₀ where b₀=b₀′/MSE(ε₀)

E) Thus, the gth element of S₁, referred to as the gth loading on component S₁ is also β_{g}⁽¹⁾, the loading in the 1-component model. Prior to showing how to extract additional components and how to obtain weights (“component weights”) for each of the K components, K>1, and how to apply the component weights to obtain composite weights for each constituent in the more general K-component model, we will provide further results from the data example introduced in Tables 1A and 1B above and introduce p-values and standardized coefficients.

### Example 1

Consider prostate cancer data where Z=1 corresponds to cancer (N1=76) and Z=0 to normals (N2=76). The results from extracting the first component obtained from 8 predictors is:

TABLE 2
Unstandardized loadings and associated p-values
for the first component in the 8-gene model

Component #1

| g | Gene (Yg) | loading | p-value |
|---|---|---|---|
| 1 | CD97 | 0.53 | 3.1E−07 |
| 2 | CDK2 | 0.60 | 1.7E−06 |
| 3 | GSK3B | 0.19 | 0.08 |
| 4 | IQGAP1 | 0.19 | 0.04 |
| 5 | MAPK1 | −0.04 | 0.73 |
| 6 | PTPRC | −0.14 | 0.26 |
| 7 | RP51077B9.4 | 1.06 | 1.4E−08 |
| 8 | SP1 | 0.04 | 0.73 |

We provide methods for assessing the importance (measured by a standardized composite weight) of each predictor in a model to predict a given outcome variable, and related methods for assessing each predictor's contribution (measured by a loading) within each component of a K-component model. —We also introduce (a) p-values, which test whether a given loading or component weight (these are different concepts as defined above) is significantly different from 0, and (b) importance measures. Subtract the mean score S̅_{1.0} for a reference group (say Z=0), to get an interpretable logit score, for the K=1 component model: Logit.1(Z)=S₁− S̅_{1.0}, where S̅_{1.0}=E(S₁|Z=0)

Par# p-Values

The linear regression associated with eq. (1) yields the usual p-values for testing the null hypothesis H₀(1.g): λ_{g}′⁽⁰⁾=0. Note that a hypothesis of the type ‘q=0’ is equivalent to the hypothesis that cq=0 for any constant c. That is, q=0 if and only if cq=0 for any c≠0. Thus, taking c=1/MSE, this p-value can also be used to test the equivalent hypothesis H₀(1.g): λ_{g}⁽¹⁾=0. The p-values associated with the loadings for component #1 are given in the right-most column of Table 1. Note that these loadings are statistically significant (at the 0.05 level) for only 4 of the 8 genes. As we will see, the corresponding loadings on the 2^{nd} component are statistically significant for the other 4 genes in the model.

Below we define standardized loadings, λ_{g}*⁽¹⁾, and show that the p-values described above can also be used to test the equivalent null hypothesis H₀(1.g): λ_{g}*⁽¹⁾=0. Similar standardized coefficients are also introduced for the weights (see section xxx).

Analogous to these predictor-level p-values, component level p-values are also available to test the significance for each component k=1, 2, . . . , K of a K-component model (see step 2D). Such p-values will be used to assess the significance of the incremental improvement in prediction provided by the kth component. For example, if we find that the 5^{th} component is not significant, we might take the 4-component model as the final model. We will see that for the 8-gene model introduced above, these p-values show that components #1, #2, and #3 are statistically significant, and further components are not significant.

B) Standardized Coefficients.

Since the Y_{g} have different standard deviations, both the loadings and composite weights will reflect their unit of measurement. If all the Y_{g} had standard deviations equal to 1, the resulting loadings and composite weights would be comparable across the g-predictors and can be used in a manner similar to p-values to identify the most important and least important predictors. Surprisingly, I have found that the appropriate standardized composite weights, β_{g}*, are determined by multiplying the corresponding unstandardized (raw) composite weights, β_{g}, by the standard deviation, σ_{g}, of Y_{g}. However, here the mathematics works out that multiplication is appropriate. Consider the following which applies to any given component, including the 1^{st} component being extracted in eq (1). Dividing both sides of eq (1) by σ_{g} to obtain standardized values for the Y_{g}, we see that λ_{g}′ get divided by σ_{g} and denoting the variance of the residual ε_{g} by MSE(ε_{g}), we see that Variance(ε_{g}/σ_{g})=MSE/σ_{g}². Working out the algebra (see eq 3 below) results in the multiplication by the standard deviation.

C) In summary, since the Y_{g} have different standard deviations, in order to compare the composite weights to determine which contributes the most and least in the model, they must be standardized. The λ_{g}′ weights can be standardized by dividing them by the associated standard deviations σ_{g}. Dividing both sides of eq (1) by σ_{g} coverts the unstandardized Y_{g} to standardized values, and the λ_{g}′ weights are transformed to λ_{g}′/σ_{g}, and MSE(ε_{g}) becomes MSE(ε_{g})/σ²_{G} Thus, applying (2) to the transformed quantities we obtain the standardized weights for each constituent by multiply weight λ_{g} by σ_{g}, to obtain: λ_{g}*=σ_{g}λ_{g}, where σ_{g} is the standard deviation of Y_{g}, estimated from the N cases:

(λ_{g}′/σ_{g})/(MSE_{g}/σ_{g}²)=σ_{g}(λ_{g}′/MSE_{g})=σ_{g}λ_{g} (3)

Accordingly this surprising result has a mathematical basis The G predictors can be ordered from low to high on the absolute value of the standardized weight, which correspond to the same ordering based on the p-values. An analogous standardized weight statistic is available for the general K-component model, and hence can be used to order the predictors from those least contributing to most contributing in the K-component model. This statistic is especially valuable for the K-component model since p-values are not easily attainable for the K-component model for K>1.

F) A standardized version of Logit.1(Z) can be obtained by dividing by its standard deviation in which case the interpretation will be in terms of standard deviation units. In particular, computing the mean Logit.1|Z=1 shows how many standard deviations away from the average normal case that the cancer cases are based on the 1-component model. Analogous statistics are available for the general K-component model.

Step 2: Extract Component k=2:

2A) Perform G univariate linear regressions, the gth of which is the regression of Y_{g} on Z and S₁, providing an estimate for the loading of the gth constituent, λ_{g}′, on component (2):

Y_{g}=α_{g.1}⁽²⁾+λ_{g.1}′⁽²⁾Z+γ₁S₁+ε_{g.1}⁽²⁾ (4)

Also get the associated p-values testing the null hypothesis H0(1.g): λ_{g}′⁽²⁾=0 and the equivalent test as applied to the loading λ_{g}⁽²⁾=0.

2B) Define Component S₂ as Follows:

$${S}_{2} = {\sum }_{g = 1}^{G} {λ}_{g .1} {Y}_{g} \qquad ( 5 )$$

where λ_{g.1} in (5) is obtained by substituting the estimates for λ_{g.1}′ obtained in (4) and MSE into the equation λ_{g.1}=λ_{g.1}′/MSE(ε_{g.1}). S₂ will be correlated with S₁. We obtain Logit.2 by estimating the b-coefficients in logistic regression of Z on S₁ and S₂:

Logit.2(Z|S₁,S₂)=α+b_{1.2}S₁+b_{2.1}S₂ (6)

As in step 1 when we obtained Logit.1, we do not bother to estimate the intercept and we obtain estimates for the b-coefficients as follows: Estimate the 2 linear regression models:

S₁=a₁+b_{1.2}′Z+d₁S₂+ε₁ (7)

S₂=a₂+b_{2.1}′Z+d₂S₁+ε₂ (8)

and compute

b_{1.2}=b_{1.2}′/MSE(ε₁) and b_{2.1}=/b_{2.1}′/MSE(ε₂) (9)

Compute the composite weight for the gth constituent in the K=2 component model as:

β_{g}⁽²⁾=b_{1.2}β_{g}+b_{2.1}β_{g.1} (10)

where β_{g} was obtained from component 1 in Step 1, and β_{g.1} is computed from (9)

2C: Similar to 1E) compute

$$α = {\sum }_{g = 1}^{G} {β}_{g}^{( 2 )} {Y}_{g} - E ( {\sum }_{g = 1}^{G} ( {β}_{g}^{( 2 )} {Y}_{g} ) \vert Z = 0 )$$

so that the mean value for Logit.2 in (6) equals 0 for Z=0.

Ordinal with estimated category scores—In the case of multiple outcome variables or a nominal outcome variable with J>2 unordered categories, the sequentially independent manner approach A1 can be easily extended by including more than a single outcome variable as a predictor. In addition, in the case of J>2 ordered categories, category scores of 0 and 1 can be assigned to the 2 extreme categories and a score can be obtained for the middle categories. The next paragraph provides a sketch of the algorithm extension for this based on work I did earlier (Magidson, 1996).

Extension to ordinal outcome with J=3 categories:

```
Z= (CaP, BPH, Normal)
Z.CaP = 1 if CaP, 0 otherwise
Z.BPH=1 if BPH, 0 otherwise
Initialize Zscores Zs1=0, Zs2(k)=.5 (or NULL), Zs3=1:
Note: For each component k=1,2,...,K:
Zs2(g) will be estimated for each g=1,2,...,G and then averaged over all g
      to get Zs2(k) for that component k
Step 1: k=1
For each g, regress Yg = a + (beta1′(1).g *Z.CaP + beta2′(1).g * Z.BPH
compute 1 beta for each g:
      compute beta.g(1) = beta1′/MSE (Note: No need to compute
                                  beta1.g and beta2.g - just use
                                  beta1′.g associated with Z.CaP
                                  which has Zscore = 1)
compute Zscores associated with k=1:
      Note: Zs1(k)=0 and Zs3(k)=1 always (for all g and all k), so
      need only compute Zs2(k)
      compute Zs2(1).g = (beta2′.g/beta1′.g)
      compute Zs2(1) = avg(g)(Zs2(1).g)
              [Note: for J>3, also compute Zsj(.g) =
              (betaj′.g/beta1′.g)]
S0 = sum(g)(beta.g*Yg)
Step 1A: regress Yg = a + (b′)*Zs(k)
b=b′/MSE
S1 = b*S0
Step 2: regress Yg = a + (beta1′) Z.CaP + (beta2′)Z.BPH + (gamma1)S1
compute 1 beta for each g:
      compute beta.g = beta1′/MSE
compute Zscores associated with k=2:
      (For k=2)
      compute Zs2(k).g = (beta2′.g/beta1′.g)
      compute Zs2(k) = avg(g)(Zs2(k).g)
      Note: Zs1(k)=0 and Zs3(k)=1 always (for all g and all k)
S2 = sum(g)(beta.g*Yg)
```

Embodiments described above in which the outcome variable is, for example, dichotomous representing cancer v. normal can be modified so that the same approach can be used to model circumstances wherein the outcome variable is an event history. In this fashion a K-component model, in which the second component is correlated with the first component, can be used to predict, for example, survival time as an event history. We have shown how to construct a gene expression model (possibly with a set of covariates) to predict an outcome variable and to reflect an underlying condition; in an analogous way, a similar model can be developed to predict survival time, again reflecting an underlying condition.

For example, in connection with cancer subjects, there may be two classes of subjects, those who are long-term survivors and the others. Latent class analysis (using the syntax version of LATENT GOLD software, v. 4.5 (available from Statistical Innovations, Inc. 375 Concord Avenue, Belmont, Mass. 02478) may be used to develop a predicted probability that a subject having specific gene expression values is a long-term survivor and also a predicted probability that the subject is not a long-term survivor. The model uses replication weights for each case, with a separate replication weight for the category of long-term survivor and a separate replication weight for the category of not a long-terms survivor. (Alternatively, other weights can be used, such as sampling weights or case weights, the latter being those used in weighted least squares (WLS). These weights are the posterior membership probabilities obtained from the latent class analysis. One can, for example, treat each weight in an analysis as a sampling weight with the case identification being used as the primary sampling unit (PSU). A K-component model then can be developed that predicts whether a subject is a long-term survivor or not, and using these weights to predict their expected survival time. In this context, the outcome variable may in fact be latent, or considered to be latent. It may be unknown whether any particular case is a long-term survivor—unlike the manifest or observed outcome variable, such as whether a case is cancerous or not. The latent outcome variable therefore corresponds to two latent classes: (i) long-term survivors and (ii) others. More generally, the latent classes might correspond to other things, like improvement under a particular proposed treatment versus no improvement with the treatment. Multiple observed indicators may be available to determine the posterior membership probabilities associated with the two classes, as obtained from a traditional latent class model, using for example, the LATENT GOLD program. Extending this approach further, the latent outcome variable may have more than two classes, in which case, the K-component model would be developed using a nominal outcome variable with J categories, a posterior membership probability being used as a weight for each of these J categories. For further information and an example, see Appendix A, pages 6-8.

As a second example, in the absence of latent classes, where each case contains L records corresponding to the L latent classes, the data file used for a survival analysis may contain a varying number of records for each case as described in Vermunt (2009). In this data file format, the final record for a given case has the outcome variable Z=1 (if the event occurred), or Z=1 (reflecting right censoring if the event did not occur) and each record is assigned a weight. The weight for each record equals 1, corresponding to a complete time period or a number between 0 and 1 corresponding to a fractional time period. For example, if the time period is 1 month and the event (death) occurred for a particular case halfway through a given monthly period, the final record for that case would be weighted by 0.5. A K-component survival model then can be developed that predicts whether the occurrence of the event, using the weights in the analysis as case weights, replication weights, or other weights, thus, taking into account the fact that some of the data is right censored.

Although we have described embodiments of the invention above employing original units with what I have termed “sequential independence” in calculating loadings and components weights, it is also possible in related embodiments of the invention to achieve sequential independence if original units are not employed. To achieve sequential independence without employing original units, one may remove the effects of previous components directly from the original units and use the residual units in place of the original units. In this manner, one need not include the previous components themselves in the models, because their effects are already incorporated into the residual units.

Examples of how Estimates are Obtained in a “Sequentially Independent Manner”

There are a number of ways of building a K-component model in a sequentially independent manner. We first show two methods, A1 and A2, that produce precisely the same models. We next show two other methods, A3 and A4, based on diminished units of the predictors, that produce the same models, albeit different from the models resulting from methods A1 and A2.

Consider a dichotomous outcome variable Z with category scores 1 and 0, a continuous predictor, say Y₁, and a first component S₁ derived in a previous step according to FIG. 1 so

$${S}_{1} = {\sum }_{g = 1}^{G} {λ}_{1 g} {Y}_{g} ,$$

where λ₁₁ is the loading for Y₁ on component S₁, and λ_{1g}, g=2, . . . , G are the loadings for the other G−1 constituents on component S₁. The loading for Y₁ on the second component, denoted λ₂₁, is interpretable as the partial log-odds ratio controlling for the first component S₁ in logistic regression model A:

Logit(Z)=α+λ₂₁Y₁+v₁S₁ (A)
where Logit(Z) denotes the log of the odds in favor of Z=1 vs. Z=0, i.e, Logit(Z)=ln[Prob(Z=1)/Prob(Z=0)].

More generally, in the step to determine the loading for Y₁ on component S_{k′}, k′>2 v₁S₁ in eq. (A) is replaced by

$${\sum }_{k = 1}^{{k}^{′} - 1} {v}_{k} {S}_{k} .$$

In this more general situation, the 2 steps given below in each of the approaches are unchanged and the estimates for the loadings obtained under approaches A1 and A2 still turn out to be identical, and the p-values are also remain identical under the 2 approaches.

The 2 different sequentially independent approaches, A1 and A2, leading to equivalent estimates for λ₂₁, and to equivalent p-values for testing H0: λ₂₁=0 are described below. Assume that Y₁ is conditionally normal given Z and S₁, so that ε₁˜N(0,σ₁²) where ε₁ is the error term in (A1):

Y₁=a′+λ₂₁′Z+γ₁′S₁+ε₁ (A1)

where parameters a, λ₂₁′ and γ₁′ are regression coefficients and σ₁² is the error variance, the estimate for which is called the mean squared error, denoted MSE(1).

As an illustration, we use data from the prostate cancer example where the training sample consists of N=152 cases (N₁=76 prostate cancer subjects and N₂=76 normals), we take Y₁ to be the measurement of gene expression for constituent SP1, and S₁ as the first component obtained in the 8-gene model, where the 8-genes are listed in Table 1A.

Approach A1: Original Units/Y₁ Used as a Dependent Variable

Step 1:

Estimate the parameters in regression equation (A1) using ordinary least squares.

Step 2:

Compute the estimate for λ₂₁ by the estimate obtained in step 1 for λ₂₁′ divided by the MSE(1) estimate obtained in step 1 for σ₁².

Under these assumptions the estimate obtained for λ₂₁ is a maximum likelihood estimate (see Lyles, 2009). Output from the SPSS linear regression routine is given in Tables 8A and 8B. We see that the estimate for λ₂₁=−0.502/0.073=−6.87. We also see from the SPSS output that the estimate −0.502 for λ₂₁′ is statistically significant (p=7.5E−19). Since we can reject the null hypothesis H0: λ₂₁′=0 with this p-value, we can also reject the equivalent hypothesis H0: λ₂₁′/MSE=0, for MSE>0. Thus, this p-value is also a valid p-value for testing the significance of the loading λ₂₁.

Maximum likelihood estimates of the component 2 loadings for the other G−1 constituents, \hat{λ}_{2g}, g=2, . . . , G (and associated p-values) are obtained in a similar fashion by applying these 2 steps. Component S₂ is then defined as

$${S}_{2} = {\sum }_{g = 1}^{G} {\hat{λ}}_{2 g} {Y}_{g} .$$

Since the 2 steps require separate linear regressions for each Y_{g}, and no more than a single Y_{g} variable is included as a predictor in each of these regressions, this approach satisfies the requirement of estimation in a sequentially independent manner.

Approach A2: Original Units/Y₁ Used as a Predictor Variable

Form the linear regression equation with the roles of Z and Y₁ reversed so that Y₁ is now a predictor variable in the linear regression (A2)

Z=a″+λ₂₁″Y₁+γ₁′S₁+ε_{z} (A2)

Step 1:

Estimate the parameters in regression equation (A1) using ordinary least squares.

Under the assumptions that 1) the outcome variable Z is continuous and 2) ε_{z} is normally distributed with constant variance, the estimated coefficient λ₂₁″ is taken without any adjustment needed as the estimate for the loading λ₂₁. Since these are the same assumptions that are made in linear regression, the estimate for λ₂ₗ″ is a maximum likelihood estimate with an associated p-value, and hence the estimate for the loading λ₂₁, is itself a maximum likelihood estimate with the same p-value. When approach A1 were used with a continuous outcome variable instead of approach A2, the resulting estimate λ₂₁′ would be adjusted to obtain the corresponding estimate obtained under approach A2, the adjustment being to multiply it by W. For simplicity but without loss of generality, if all variables are standardized to have variance 1 prior to performing step 1, we have:

W=(1−r_{ZS}_{₁}²)/(1−r_{Y}_{₁}_{S}_{₁}²), where r denotes the associated correlation coefficient.

For example, Table 8A and Table 9A provide output from the SPSS linear regression routine obtained under approaches A1 and A2 respectively. The column marked ‘Standardized Coefficients’ provides the estimated regression coefficients that would be obtained if all variables Z, S₁ and Y₁ were standardized to have variance 1. For this example, we have r_{ZS}_{₁}=0.453 and r_{Y}_{₁}_{S}_{₁}=0.806. Hence, W=2.272. Multiplying the estimate obtained from approach A1 by 2.272, we obtain the loading estimate −0.966 (−0.425×2.272=−0.966), which is seen to equal the corresponding standardized coefficient estimate obtained from approach A2 (−0.966 in Table 9A), which is used as the estimated loading.

In our particular example with Z dichotomous, we ignore the fact that Z is not continuous and ignore the fact that the error term can not be normally distributed, since for our purpose this does not matter. Under the assumption of a dichotomous or ordinal outcome variable Z, we obtain the loading by applying the following adjustment.

Step 2:

Estimate λ₂₁ to be the estimate obtained for λ₂₁″ divided by the estimated MSE(Z).

Relevant output from the SPSS linear regression routine is highlighted in Tables 9A and 9B. We see that the estimate for λ₂₁=−0.819/0.119=−6.87, which matches the estimate obtained from approach A1 exactly. We also see from the SPSS output that the estimated p-value associated with the estimate −0.966 for λ₂₁″ obtained in approach A2 matches the p-value obtained in approach A1 exactly. This is not a coincidence, as the formulae are equivalent. Thus, the p-value for testing the null hypothesis Ho: λ₂₁=0 can equivalently be obtained using approach A1 and since the results are equivalent to those obtained in approach A1 which provides maximum likelihood estimates, the corresponding estimates obtained from approach A2 are also maximum likelihood estimates.

Since the 2 steps require separate linear regressions for each Y_{g}, and no other Y_{g} variables are included as either dependent or predictor variables in these regressions, this approach satisfies the requirement of estimation in a sequentially independent manner.

Extension of Approaches A1 and A2

Approach A1 is a preferred embodiment over approach A2 because it can more easily be generalized to handle nominal categorical outcome variables with more than 2 (unordered) categories, such as normals (j=1) vs. prostate cancer (j=2) vs. subjects with benign prostate hyperplasia (BPH), or some other disease, where BPH or the other disease (j=3) may be associated with different underlying conditions than prostate cancer. Generalizations of A1 to 1) an outcome variable with J>2 ordered categories where the relative distance between the categories is unknown and must be estimated, 2) multiple outcome variables and to 3) the handling of missing data for some of the Y_{g} are also easy.

For example, in the case of a nominal categorical outcome variable with J=3 categories, we can define Z1=1 for cases having outcome j=1 and 0 otherwise, and define a second outcome variable Z2=1 for cases having outcome j=2 and 0 otherwise.

The logit model in (A) becomes 2 separate logit models:

Logit(Z1)=α₁+λ₂₁₁Y₁+v₁S₁

Logit(Z2)=α₂+λ₂₁₂Y₁+v₂S₁

Under approach A1, we include both of these outcome variables in the linear regression model as follows:

Y₁=a′+λ₂₁₁′Z₁+λ₂₁₂′Z₂+γ₁′S₁+ε₁ (A1.2)

The steps of approach A1 generalize as follows:

Step 1:

Estimate the parameters in regression equation (A1.2) using ordinary least squares.

Step 2:

Estimate λ₂₁₁ to be the estimate obtained in step 1 for λ₂₁₁′ divided by the estimate obtained in step 1 for MSE(1), and estimate λ₂₁₂ as the estimate obtained in step 1 for λ₂₁₂′ divided by the estimate obtained in step 1 for MSE(1). More generally, when J>3, λ₂₁₁′Z₁+λ₂₁₂′Z₂ is replaced by

$${\sum }_{j = 1}^{J - 1} {λ}_{21 j}^{′} {Z}_{j} .$$

The generalized approach described above also applies when there are 2 (or more) separate outcome variables, say Z1=1 for prostate cancer, 0 for normals and Z2=1 for smokers and Z2=0 for non-smokers.

For the corresponding generalizations under approach A2, eq. (A1.2) is replaced by J−1 regression equations where in the jth equation Zj is regressed on the components and the other J−2 outcome variables. For example, for J=3 we have the following 2 equations:

Z₁=a″+λ₂₁₁′Y₁+υ₁′Z₂+γ₁*S₁+ε₁′ and Z₂=a₂″+λ₂₁₂′Y₁+υ₂′Z₁+γ₂*S₁+ε₂′

Approach A3: Diminished Units/Y₁ Used as a Dependent Variable
Next suppose that at a given step after the kth component has been extracted, components S₁, S₂, . . . , S_{K} are regressed out of each Y_{g}, and that Y_{g} is replaced by the orthogonal components or diminished units Y_{g.12 . . . k}. For concreteness, let us suppose again that we have a single component S₁. The orthogonal component of Y₁, denoted Y_{1.1}, is the residual obtained after regressing out the linear effect of S₁. The following linear regression show how the orthogonal component for Y₁ is obtained:

Y₁=a₁+b_{1.1}S₁+Y_{1.1}

where the parameters are again estimated by ordinal least squares, and the residual is then obtained in the usual manner:

Y_{1.1}=Y₁−(a₁+b_{1.1}S₁)

Approach A3 involves the use of the linear regression where the components themselves are omitted, since there effects have been removed directly. Thus, for example, the approach corresponding to Approach A1 where the constituent variables are used as predictors in the regression, becomes:

Z=a′″+λ₂₁′″Y_{1.1}+ε_{z}′ (A3)

Again, we apply the 2 steps:

Step 1:
Estimate the parameters in regression equation (A3) using ordinary least squares.

Step 2:
Estimate λ₂₁ as the estimate obtained in step 1 for λ₂₁′″ divided by the estimate obtained in step 1 for MSE(ε′_{z}).

The second component under this approach, denoted S_{2.1}, is then defined as

$${S}_{2.1} = {\sum }_{g = 1}^{G} {λ}_{2 g} {Y}_{g .1} .$$

Since S_{2.1} is defined as a linear combination of variables that are uncorrelated with S₁, the second component, obtained in this sequentially independent manner, is also uncorrelated with S₁. This approach is a preferred embodiment for situations where none of the constituent variables are suppressor variables.

Note that components after the first component are expressed in terms of diminished units. These can be transformed back to the original units using a linear transformation. An easy way to determine the weights associated with the original units is to compute them first in terms of the diminished units, and then regress each component after the first component, one at a time, on the Y_{g} variables as predictors in their original units. As a check, the R² statistic should equal 1 indicating perfect prediction of the components, and the estimated regression coefficients will be the appropriate loadings. These loadings, together with estimated component weights can be used to obtain composite weights in the same manner as components obtained using the original units.

Approach A4: Diminished Units/Y₁ Used as a Predictor Variable

Approach A4, is analogous to approach A2, except that diminished units are used as in approach A3.

The measure of importance, defined in terms of standardized composite weights and used as preferred criteria in our variable reduction approach can be applied to components derived using any of the 4 approaches described above. Tables 8A and 8B: Approach A1/Linear Regression: SP1˜Z, S1 Computation of Loading of SP1 on 2^{nd} component: λ₂₁=−0.502/0.073=−6.87

TABLE 8A
Coefficients^{a}

| | | Unstandardized | | Standardized | | |
|---|---|---|---|---|---|---|
| | | Coefficients | | Coefficients | | |
| Model | | B | Std. Error | Beta | t | Sig. |
| A1 | (Constant) | −4.634 | .864 | | −5.366 | 3.0E−07 |
| | Z | −.502 | .049 | −.425 | −10.196 | 7.5E−19 |
| | S1 | .523 | .022 | .999 | 23.958 | 5.8E−53 |

TABLE 8B
ANOVA^{b}

| | | Sum of | | | | |
|---|---|---|---|---|---|---|
| Model | | Squares | df | Mean Square | F | Sig. |
| A1 | Regression | 41.977 | 2 | 20.989 | 287.267 | .000^{a} |
| | Residual | 10.886 | 149 | .073 | | |
| | Total | 52.864 | 151 | | | |

### Tables 9A and 9B: Approach A2/Linear Regression: Z˜SP1, S1

Computation of Loading of SP1 on 2^{nd} component: λ₂₁=−0.819/0.119=−6.87

TABLE 9A
Coefficients^{a}

| | | Unstandardized | | Standard- | | |
|---|---|---|---|---|---|---|
| | | Coefficients | | ized Coef- | | |
| | | | Std. | ficients | | |
| Model | | B | Error | Beta | t | Sig. |
| A2 | (Constant) | −8.248 | .998 | | −8.261 | 7.2E−14 |
| | SP1 | −.819 | .080 | −.966 | −10.196 | 7.5E−19 |
| | S1 | .547 | .042 | 1.233 | 13.007 | 2.5E−26 |

TABLE 9B
ANOVA^{b}

| | | Sum of | | | | |
|---|---|---|---|---|---|---|
| Model | | Squares | df | Mean Square | F | Sig. |
| A2 | Regression | 20.219 | 2 | 10.110 | 84.719 | .000^{a} |
| | Residual | 17.781 | 149 | .119 | | |
| | Total | 38.000 | 151 | | | |

Fast Variable Reduction

In accordance with further embodiments of the invention, a fast variable reduction algorithm can be employed following model development that reduces the number of variables in the K-component model to increase the predictive power by removing irrelevant predictors, or at least retain a high percentage of the predictive power with only a subset of the G predictors. In one embodiment, the absolute value of the standardized weight associated with a particular outcome variable, |β_{g}*|, is used as the measure of variable importance, which assesses the importance of the g-th predictor variable in predicting that outcome variable. Thus, for a given K-component model, the variable that is the least important is eliminated, where importance is quantified by the absolute value of the variable's standardized coefficient, where the standardized coefficient is defined as:

β_{g}*=σ_{g}β_{g}

In practice, in the case of large G, more than 1 predictor can be eliminated at a time. For example, at each step we can eliminate the 1% of the predictors that are least important until P<100, at which time we can begin eliminating 1 predictor at a time. This process can continue until 1 predictor remains.

Note that when G is reduced to K, the model becomes ‘saturated’ and is equivalent to the traditional regression model. In order to reduce the number of predictors further, we maintain the saturated model by reducing K so that G=K. Thus, for example, for K=4, when we step down to 3 predictors, we reduce K so K=3, so in that case we examine the measure of predictor importance in the 3-component model.

The use of M-fold cross-validation is recommended for determining the optimal value for the tuning parameters K (number of model components) and G (number of predictors to be included in the model) for a given criterion such as accuracy. For example, in the case of a dichotomous dependent variable (cancer vs. normal), accuracy corresponds to the total number of cases classified correctly divided by the total number of cases. Thus, suppose we have 5 folds (generally, the number of folds is taken to be between 5 and 10). We apply the model estimation and step-down algorithm 5 times, each time excluding 1 of the folds, and then apply the model to score the cases in the omitted fold. Using only the predictions on the excluded folds, we compute the accuracy based on all cases, referred to as the cross-validated accuracy, or CV-ACC.

For computational efficiency, when estimating the model and applying the step-down procedure, the foregoing procedure is first applied for K=1 components, then K=2 components, . . . , up through say K=8 components, and each time we step down to G=1 predictor. Since in practice, the optimal number of components will rarely be greater than 8, one can be fairly sure of obtaining a good model with K<9. For a given number of components K, the optimal number of predictors G*(K), can then be determined, and (G*, K*) can be determined as the combination minimizing the loss function. Thus, G* predictors will be retained where G* is the best of the P*(K), K=1, . . . , 8, and K* will be the optimal number of components associated with the G* predictors.

Evaluating up to only 8 components saves computer resources since the speed of correlated component regression (CCR), as described above, increases substantially as the number of components increases. Since estimation utilizes a sequential process, most of the sufficient statistics from previous runs can be reused. CCR is very fast with a small number of components.

Let A(K)=accuracy of the K-component model based on the optimal number of predictors G*(K). Then, if A(1)<A(2)<A(3)<A(4)>A(5), we might stop after evaluating K=5 and not evaluate K=6, 7, or 8, thereby saving more computer time. That is, if the 5-component model fails to provide a solution that improves over the 4-component, we might take K*=4, and G*=G*(4). As a somewhat more conservative approach, we might also evaluate K=6 to check that performance continues to degrade.

The use of M-fold cross-validation is used in data mining techniques to determine the optimal value for one or more ‘tuning parameters.’ It is used for example, to obtain the single tuning parameter ‘lambda’ in the lasso penalized regression approach. In accordance with embodiments of the present invention, it may be used to optimize the two tuning parameters, G and K. Cross-validation is performed in a particularly efficient way by application to each component separately, and evaluate only a small number of models (those with K in a specified range), with limitation to small values of K. In practice with high-dimensional data, we have found that the best model is rarely one with K>8.

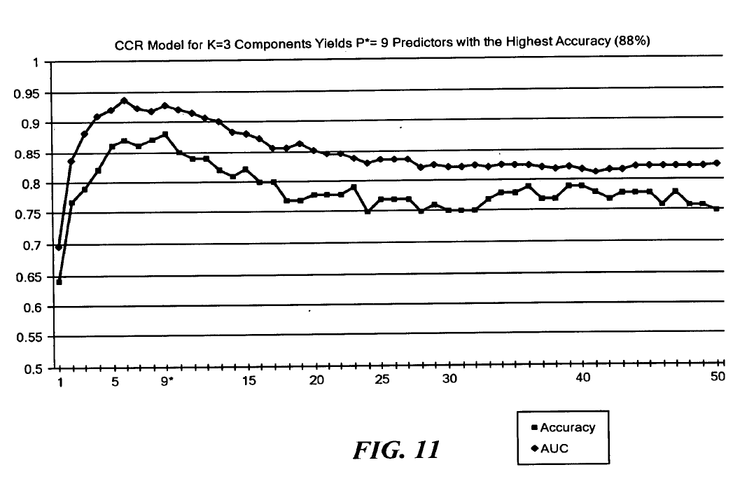

Referring now to FIG. 11, an example is shown of application of the fast variable reduction technique to correlated component regression, taught herein in accordance with embodiments of the present invention. The optimal number of predictors is the one that has the highest cross-validated accuracy, where cross-validated accuracy is plotted as a function of the number of predictors in the superior plot of FIG. 11. In the case of ties among those with the highest accuracy, an algorithm is applied to break the tie. In that case, reference may be made to the lower plot of FIG. 11 which shows the Area Under the Receiver Operating Characteristic (ROC) Curve (the AUC). A preferred tie-breaking algorithm is the selection of the number of predictors exhibiting the highest AUC. In the example shown in FIG. 11, P*=9 is the optimal number of predictors in the 3-component model. (Note: In FIG. 11 we use P to denote the number of predictors rather than G used earlier)

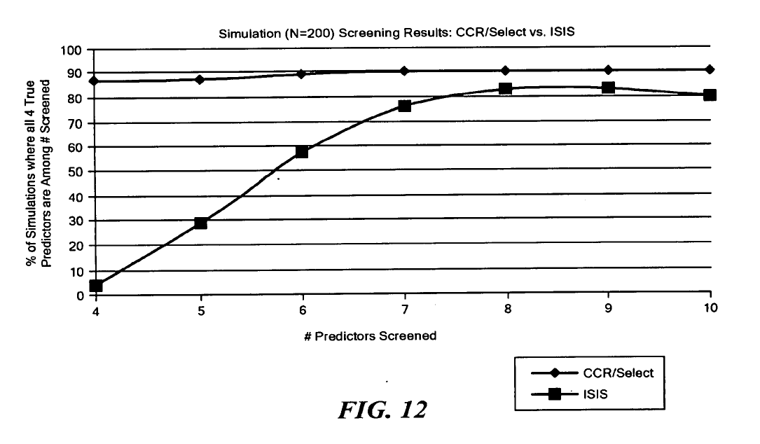

Details of Simulation Relating to FIG. 12.

For ultra-high dimensional data with many irrelevant predictors, typical with gene expression data, by chance some large loadings for the many irrelevant predictors may dominate the first component, leading to unreliable results. To avoid this, an initial variable selection ‘screening’ step may be performed to reduce # predictors to a manageable number prior to model estimation.

Most current screening methods should be avoided because they typically exclude important suppressor variables. These include supervised principle components analysis/SPCA: (Bair, et. al. et al., 2006), as well as the SIS approach (Fan and Lv, 2008). Fan and Lv (2008) distinguish between high and ultra-high dimensional data, and propose ISIS to pre-screen predictors in ultra-high dimensional data where suppressor variables may be present. Fan et. al. (2009) present ISIS simulation results based on 3 prime predictors and one suppressor variable which shows a large improvement over SIS.

While promising, ISIS has been criticized for having too many tuning parameters. Embodiments of the present invention use a single parameter P*, or the desired number of predictors to be selected and outperform ISIS on the simulation data provided in Fan. et. al (2008, 2009) that includes a suppressor variable. Our screening procedure (which herein we call “CCR/Screen”) is based on a restricted 3-component CCR model, developed as follows:

For Component 1:

Apply Inverse normal transformation to Comp. #1 p-vals>0.5 to get Zval1, and use 2-class truncated normal mixture (latent class) model on −Zval1 to identify the G₁ most significant predictors (G, predictors whose posterior prob>0.5 of being in class with lowest p-vals). Set component #1 loadings to 0 for all but G*₁ predictors, where G*₁=min{max{G₁, 2}, 10}.

For Component 2:

Compute Zval2=Inverse normal of Comp #2 p-vals>0.5 (excluding the G*₁ predictors identified above), and estimate latent class model on −Zval2 to identify G₂ predictors assigned to lowest component #2 p-val class. Set the loading to 0 for all but the G*₂ predictors with lowest p-values (excluding the G*₁ predictors), where G*₂=min {max {G₂, 1}, G₁}.

For Component 3:

Set the loading to 0 for all but the M predictors with lowest p-values. Introduce CCR/Select and compare its performance with ISIS based on Fan et. al. et al. (2009) simulated data.

Here we simulated 100 data sets with 4 true predictors, the 4th being a suppressor variable. The data were simulated according to specifications of Fan et. al. et al. (2009) with N=200: Logistic Regression with β₀=0, effects of primes β₁=β₂=β₃=4; effect of suppressor=β₄=−6\sqrt{2}. and predictors X₅-X₁₀₀₀ are irrelevant: β₅=β₆= . . . =β₁₀₀₀=0.

$$Logit ( Z ) = {β}_{0} + {\sum }_{g = 1}^{1000} {β}_{g} {X}_{g}$$

where X follows a multivariate normal distribution with means 0, variances 1 and all correlations=0.5 except that corr(X₁,X₄)=1/\sqrt{2} for I≠4.

CCR/Screen includes the suppressor variable X₄ among the 10 top predictors 91% of the time compared to only 80% for ISIS. In addition, ISIS performed very poorly when fewer than 7 predictors were selected.

Various embodiments described herein may be implemented using a computer system including a processor controlled by instructions stored in a memory. The memory may be random access memory (RAM), read-only memory (ROM), flash memory or any other memory, or a combination thereof, suitable for storing control software or other instructions and data. Some of the functions performed by embodiments herein have been described with reference to flowcharts and block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While embodiments of the invention have been described with exemplary embodiments, it will be understood by those of ordinary skill in the art that modifications to, and variations of, the illustrated embodiments may be made without departing from the inventive concepts disclosed herein. For example, although embodiments have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiment(s). The embodiments of the invention described above are intended to be merely exemplary; numerous variations and modifications will be apparent to those skilled in the art. All such variations and modifications are intended to be within the scope of the present invention as defined in any appended claims.

### REFERENCES

Magidson, Jay (1996) “Maximum Likelihood Assessment of Clinical Trials Based on an Ordered Categorical Response.” Drug Information Journal, Maple Glen, Pa.: Drug Information Association, Vol. 30, No. 1, 143-170.
Gromping, Ulrike (2009) Variable Importance Assessment in Regression: Linear Regression versus Random Forest, The American Statistician, November 2009. Vol 63, No. 4, pp 308-319.
HORST, P. (1941). The role of predictor variables which are independent of the criterion. Social Science Research Bulletin, 48, 431-436.
Lynn, Henry S. (2003) Suppression and Confounding in Action. The American Statistician, Vol. 57, 2003.
Friedman, Lynn and Wall, Melanie. (2005). “Graphical Views Of Suppression And Mutlicollinearity In Multiple Linear Regression”. American Statistician, May 2005. Vol 59, No. 2, pp 127-136
Lyles R. H., Y. Guo and A. Hill (2009). “A Fresh Look at the Discrimination Function Approach for Estimating Crude or Adjusted Odds Ratios.” The American Statistician, November 2009. Vol 63, No. 4, pp 320-327.
Hancza, et al. (2007). “Feature Construction from Synergic Pairs to Improve Microarray-based Classification.” Bioinformatics. Vol. 23, No. 21 2007, pages 2866-2872.
Komarek, Paul and Moore, Andrew. (2006). “Implementation of Logistic Regression with Truncated IRLS.” Carnegie Mellon University, School of Computer Science.
Boulesteix, Anne-Laure and Strimmer, Korbinian. (2006). “Partial Least Squares: a Versatile Tool for the Analysis of High-dimensional Genomic Data.” Briefings in Bioinformatics. Vol. 8. No. 1. pp 32-44.
Fort, Gersende and Lambert-Lacroix, Sophie. (2003). “Classification Using Partial Least Squares with Penalized Logistic Regression.” IAP-Statistics, TR0331.
Marx, Brian. (1996). “Iteratively Reweighted Least Squares Estimation for Generalized Linear Regression.” Technometrics. November 1996, Vol. 38, No. 4.
Ding, B. and R. Gentleman (2005) “Classification Using Penalized Partial Least Squares.” J Comput Graph Stat 2005; 14:280-98.
Tibshirani R, Hasti T, Narasimhan B, et al. (2002). Diagnosis of Multiple Cancer Types by Shrunken Centroids of Gene Expression.” Proc Natl Acad Sci 2002; 99:6567-72.
Ding, Beiying and Gentleman, Robert (2009) “Classification Using Generalized Partial Least Squares.” gpls package.
McIntosh A R, Bookstein F L, Haxby J V, and Grady G L. (1996). “Spatial Pattern Analysis of Functional Brain Imagines Using Partial Least Squares.” Neuroimage 3, 143-157. Article No. 0016.
Vermunt, J. K. (2009). Event history analysis. In: R. Millsap and A. Maydeu-Olivares (eds.) Handbook of Quantitative Methods in Psychology, 658-674. London: Sage.
Fung, K. Y. and B. A. Wrobel (1989) The Treatment of Missing Values in Logistic Regression, Biometrical Journal, Volume 31 Issue 1, 35-47.
Fan, J. and J. Lv (2008). Sure Independence Screening for Ultra-High Dimensional Feature Space (with Addendum), Journal of the Royal Statistical Society: Series B (Statistical Methodology), Volume 70, Issue 5, pages 849-911, November.
Bair, E., T. Hastie, P. Debashis, and R. Tibshirani (2006). Prediction by supervised principal components. Journal of the American Statistical Association 101, 119-137.
Fan, J., R. Samworth, and W. Yichao (2009). Ultrahigh Dimensional Feature Selection: Beyond the Linear Model, Journal of Machine Learning Research 10, 2013-2038.

1. An improved method of predicting an outcome variable of an observed phenomenon based on values of a panel of G observed constituents, G≧3, and for which there exist N>4 cases, the cases collectively providing values for all constituents of the panel, wherein, for each constituent, there are at least two cases having mutually distinct values, and wherein at least two cases have mutually distinct values for the outcome variable, and with respect to which there is provided at least one additional case in which values for at least some constituents of the panel of constituents are provided and from which the outcome variable is to be predicted, the method comprising:
(a) loading into a digital computing device a model that predicts the outcome variable based on constituent values inputted to the digital computing device from the at least one additional case, wherein the model has been developed by:
establishing in a digital computer a machine for developing a K-component linear model of the observed phenomenon, wherein such model (i) predicts an outcome variable for the phenomenon, based on values of the panel of G observed constituents, G≧3, and (ii) is developed from the N>4 cases, wherein the machine implements processes comprising:
computing in a series of computer processes a weighted sum of K>1 components, each one of the K components having a component weight, each component subsequent to a first component being itself a linear combination of constituents in the panel, wherein the first component is by itself significantly predictive of the outcome variable, and a second component is correlated with the first component;
wherein the computing in a series of computer processes includes
(i) determining, from the N cases, in a sequentially independent manner, loadings, for each constituent within any given one of the components subsequent to the first component, and storing the loadings, and
(ii) determining and storing the component weights, wherein each component subsequent to the first component enhances accuracy of prediction collectively by all preceding components; and
using the machine thus established to develop the model; and
(b) inputting into the digital computing device the constituent values from the at least one additional case and using the model in the digital computing device to predict a value for the outcome variable for each of the at least one additional case.

2. A digital computing device that predicts an outcome variable of an observed phenomenon based on values of a panel of G observed constituents, G≧3, and for which there exist N>4 cases, the cases collectively providing values for all constituents of the panel, wherein, for each constituent there are at least two cases having mutually distinct values, and wherein at least two cases have mutually distinct values for the outcome variable, and with respect to which there is provided at least one additional case in which values for at least some constituents of the panel of constituents are provided and from which the outcome variable is to be predicted, the device comprising:
a processor; and
a memory storing instructions, executable by the processor; wherein such instructions:
(a) cause the computing device to perform processes that include storing constituent values inputted to the digital computing device from the at least one additional case; and
(b) establish in the computing device a model that predicts a value for the outcome variable for each of the at least one additional case, wherein the model has been developed by:
establishing in a digital computer a machine for developing a K-component linear model of the observed phenomenon, wherein such model (i) predicts an outcome variable for the phenomenon, based on values of the panel of G observed constituents, G≧3, and (ii) is developed from the N>4 cases, wherein the machine implements processes comprising:
computing in a series of computer processes a weighted sum of K>1 components, each one of the K components having a component weight, each component subsequent to a first component being itself a linear combination of constituents in the panel, wherein the first component is by itself significantly predictive of the outcome variable, and a second component is correlated with the first component;
wherein the computing in a series of computer processes includes
(i) determining, from the N cases, in a sequentially independent manner, loadings, for each constituent within any given one of the components subsequent to the first component, and storing the loadings, and
(ii) determining and storing the component weights, wherein each component subsequent to the first component enhances accuracy of prediction collectively by all preceding components; and
using the machine thus established to develop the model.

3. A computer-readable non-transitory storage medium encoded with instructions that, when loaded into a computer, establish a machine for developing a K-component linear model of an observed phenomenon, wherein such model (i) predicts an outcome variable for the phenomenon, based on values of a panel of G observed constituents, G≧3, and (ii) is developed from N>4 cases, the cases collectively providing values for all constituents of the panel, wherein, for each constituent there are at least two cases having mutually distinct values, and wherein at least at least two cases have mutually distinct values for the outcome variable, wherein the machine implements processes comprising:
computing in a series of computer processes a weighted sum of K>1 components, each one of the K components having a component weight, each component subsequent to a first component being itself a linear combination of values of each constituent in the panel, wherein the first component is by itself significantly predictive of the outcome variable, and a second component is correlated with the first component;
wherein the computing in a series of computer processes includes
(i) determining, from the N cases, in a sequentially independent manner, loadings, for each constituent within any given one of the components subsequent to the first component, and storing the loadings, and
(ii) determining and storing the component weights, wherein each component subsequent to the first component enhances accuracy of prediction collectively by all preceding components.

4. An invention according to claim 1, wherein the machine implements further processes comprising:
in a second series of computer processes, determining a composite weight for each constituent in each K-component model by summing, over all K components, the product of the constituent's loading in each component and the corresponding weight for such component, and storing and using the composite weight to establish a measure of predictive importance of each constituent in the K-component model; and
in a third series of computer processes, simplifying the model by removing at least one constituent according to a pre-specified rule taking into account the measures of predictive importance of at least one constituent.

5. An invention according to claim 1, wherein the panel of constituents includes gene constituents, and each gene constituent in any instance has a gene expression value, and, optionally, each output outcome variable characterizes quantitatively a state of a subject as to a biological condition.

6. An invention according to claim 5, wherein at least one of the constituents is a covariate.

7. An invention according to claim 4, wherein simplifying the model by removing at least one constituent according to a pre-specified rule that further takes into account the measures of predictive importance of each constituent.

8. An invention according to claim 4, wherein establishing a measure of predictive importance includes converting the composite weights into standardized weights so that a constituent having a lowest standardized composite weight contributes least in predicting the outcome variable.

9. A method according to claim 8, wherein converting the composite weights into standardized composite weights includes determining a magnitude of the product of each constituent composite weight and a standard deviation of the constituent computed from the N cases.

10. An invention according to claim 4, wherein the machine implements further processes comprising:
repeating the second and third series of computer processes to remove constituents until the model's accuracy of prediction is optimized with respect to the number of constituents employed therein.

11. An invention according to claim 1, wherein the step of determining the loadings in a sequentially independent manner for each constituent is based optionally on a maximum likelihood method and optionally on an assumption of normally distributed errors.

12. An invention according to claim 8, wherein converting the composite weights into standardized composite weights includes determining a magnitude of the product of each of a plurality of constituent composite weight and a standard deviation of the constituent computed from the N cases.

13. A method according to claim 8, wherein using the composite weight to establish a measure of predictive importance includes determining a monotonic function of a product of the composite weight and a standard deviation of the constituent associated with the composite weight, such function preserving an order of importance of the constituents determined by the absolute value of the product.

14. An invention according to claim 4, wherein, in the third series of processes, simplifying the model includes using a pre-specified rule requiring a retention set of constituents to remain in the model regardless of measures of predictive importance thereof.

15. An invention according to claim 4, wherein:
(i) the second series of computer processes includes converting the composite weights into standardized composite weights so that a constituent having a lowest standardized composite weight contributes least in predicting the outcome;
(ii) the third series of computer processes includes removing the constituent having the lowest standardized composite weight from the new model;
the machine implements further processes including:
(iii) a fourth series of computer processes including determining new composite weights using the constituents remaining in the model; and the machine performs the second, third, and fourth computer processes iteratively until the new model satisfies a design criterion.

16. An invention according to claim 15, wherein the design criterion is to include no more than a specified number of constituents.

17. An invention according to claim 15, wherein the design criterion is to remove constituents from the model until just before the model loses accuracy of prediction by a desired amount.
